(19) United States
(12) Patent Application Publication
(10) Pub. No.: US 2026/0110817 A1
(43) Pub. Date: Apr. 23, 2026

(54) IMPROVING ACCURACY AND PRECISION OF MAPPING OF SMALL-SCALE MAGNETIC ANOMALIES

(71) Applicant: UNIVERSITY OF MARYLAND, COLLEGE PARK, College Park, MD (US)

(72) Inventors: Heidi Myers, Bowie, MD (US); Daniel P. Lathrop, University Park, MD (US); Vedran Lekic, Washington, DC (US)

(21) Appl. No.: 19/365,831

(22) Filed: Oct. 22, 2025

Related U.S. Application Data
(60) Provisional application No. 63/711,140, filed on Oct. 23, 2024.

(51) Int. Cl. G01V 3/08

(52) U.S. Cl. CPC G01V 3/081

(57) ABSTRACT

Methodology of using operational data of a vehicle to model and reduce vehicle magnetic self-noise allowing to improve dramatically data fidelity and spatial coherence when surveying a chosen scene to identify small-scale magnetic anomalies, the presence of which would otherwise be obfuscated. The methodology involves at least measuring parameters representing vehicle's operation; identifying the vehicle-orientation-dependent vehicle environment (background, ambient) magnetic field; selecting a vehicle magnetic field corrective model based on the parameters of vehicle's operation; collecting training data for the model while operating the vehicle; determining vehicle magnetic field corrective model parameters based on the parameters of vehicle's operation, the chosen model, and the training data; and forming a map of distribution of the magnetic field at the chosen scene (with the use of the chosen mode employing the vehicle magnetic field corrective model parameters) in which the magnetic noise is substantially reduced.

### CROSS-REFERENCE TO RELATED APPLICATIONS

This patent application claims the benefit of U.S. provisional application No. 63/711,140 filed on Oct. 23, 2024, and titled “Method for Vehicle Magnetic Self-Noise Reduction”, the entire disclosure of which is incorporated by reference herein.

### STATEMENT REGARDING FEDERALLY SPONSORED RESEARCH OR DEVELOPMENT

This invention was made with government support under IIP2044611 awarded by the National Science Foundation. The government has certain rights in the invention.

### TECHNICAL FIELD

The present invention relates to measurements of magnetic anomalies with the use of a vehicle equipped with at least one magnetometer and, in particular, a methodology allowing a user to measure and map a distribution of small-scale (small magnetic strength) magnetic anomalies across a chosen scene surveyed with such vehicle in the presence of magnetic self-noise generated by the vehicle and in the presence of the Earth's large scale and small scale magnetic fields that would otherwise obfuscate the magnetic signals of interest.

### RELATED ART

Magnetic surveys conducted with the use of various vehicles (be those drones, motor-vehicles, planes, or any other appropriate vehicles the examples of which are itemized below)) have a wide range of applications, including geologic mapping, detection of anthropogenic materials such as utilities, archaeological artifacts, and explosive remnants of war (ERW, such as landmines for example). Detecting small-size, small-magnetic-fled-amplitude anomalies is particularly challenging—whether such detection is carried out with the use of vector or scalar magnetometers. This is partly due to cultural and space weather noise sources that can obfuscate anomalies when used in isolation (see, for example, M. E. Kolster, et al., Remote Sensing, vol. 14, no. 5, p. 1134, 2022). Magnetic gradiometry may solve the issue of cultural and space weather noise (J. B. Nelson, Geophysics, vol. 53, pp. 957-966, 1988), but does not address the impact of the platform of the vehicle itself, which inevitably introduces local, non-trivial, time-varying magnetic signatures that act like noise thereby at least masking true values of the magnetic signals being measured or even making the detection of the sought-after anomalies practically impossible by reducing the signal-to-noise ratio to that below a level of detection. Magnetometer systems (magnetic gradiometers that include a set or array of magnetic sensors—or magnetometers—including at least one magnetometer) are often slung-loaded to a vehicle to avoid these unwanted/parasitic (vehicle-generated or spurious)/noise signals. (Specifically, in such a case a magnetometer system with which the vehicle is equipped is suspended below the vehicle at a distance at which the vehicle-generated magnetic field(s), contributing such noise to the measurement of the distribution of magnetic field across the surveys scene, are practically not sensed by the magnetometer.) However, slung-loaded systems understandably become simply inappropriate in cases requiring very low-altitude flying (when a drone or a plane is used), or using a motor vehicle. Additionally, swinging motions of the magnetometer system below the vehicle during the vehicle operation restrict users to being able to employ typically the so-called total field magnetometers due to the pointing sensitivity of vector magnetometers (Y. Wang, et al., Micromachines, vol. 11, no. 9, p. 803, 2020). On the other hand, while the use of magnetometer arrays rigidly mounted to the vehicle enables full magnetic gradiometry (which reduces space weather and cultural noise, and optimizes the interpretability of field data), such arrangement simply cannot avoid registering the vehicle's own magnetic signature as part of the collected magnetic field data.

There remains, therefore, an unresolved need in methodology for accurate and precise determination of the presence and strength of magnetic anomalies across the scene despite the vehicle's own magnetic signature (magnetic self-noise) and/or despite high sensitivity of a chosen magnetometer to an abrupt change of its position and/or orientation in space.

Implementations of the idea of the present invention address this and other related problems persisting in related art.

### SUMMARY

Embodiments of the invention provide a vehicle-based apparatus configured to reduce errors of detecting magnetic anomalies at a chosen scene (the scene to be mapped) with the use of a vehicle. Such apparatus includes the vehicle itself, a magnetometer system containing a set of magnetic sensors attached to the vehicle (preferably but not necessarily-rigidly attached); a vehicle sensor system at least electrically coupled with an operational component of the vehicle; and a programmable electronic circuitry (such as a processor, whether located onboard or remote with respect to the vehicle) in operable communication with the set of magnetic sensors and the vehicle sensor system. Such electronic circuitry is operably connected with a tangible, non-transitory storage medium that contains a set of codes or instructions thereon which, when loaded on the programmable electronic circuitry, enable or configured the electronic circuitry to receive ambient magnetic data characterizing an ambient magnetic field at a location and altitude of the vehicle; to transform the ambient magnetic data to geometrically corrected ambient magnetic data representing a geometrically corrected ambient magnetic field dependent on an orientation of the vehicle at the location and altitude; to determine characteristics of a local magnetic field produced by the vehicle, operating to detect the magnetic anomalies at the location of the scene, based at least on vehicle operational parameters measured with the vehicle sensor system while said operating; and to generate an image (such as, in one example, a map or a multi-layer map) of a spatial distribution of the magnetic anomalies across an area of the scene by at least compensating the geometrically corrected ambient magnetic field with a corrective magnetic field determined with the use of the characteristics of the local magnetic field. The vehicle-based apparatus may include an aerial vehicle, an unmanned aerial vehicle (UAV), an autonomously controlled UAV, a ground-based vehicle, an unmanned ground vehicle (UGV), an autonomously controlled UGV, a subterranean manned or unmanned vehicle, a manned spacecraft, or an unmanned spacecraft, to name just a few, while the magnetometer system may include a triaxial magnetometer, a magnetometer array, a scalar magnetic sensor, a vector magnetic sensor, a quantum magnetic field sensor, or a combination thereof. In at least one implementation the vehicle sensor system includes a first vehicle sensor configured to measure a vehicle operational parameter such as a time-dependent power bus current of the vehicle, and a second vehicle sensor configured to measure a rotational speed of the motor during said operating. Substantially in every implementation of the apparatus, the vehicle sensor system is configured to measure at least yaw, pitch, and roll of the vehicle at the location during the operation of the vehicle. Substantially in every implementation of the apparatus—the programmable electronic circuitry may be configured to determine the location, altitude, and/or orientation of the vehicle based on data provided by a dedicated vehicle-locating system of the apparatus. Alternatively or in addition, the programmable electronic circuitry may be configured to carry out any of (i) transforming the ambient magnetic data to geometrically corrected ambient magnetic data, (ii) determining the characteristics of the local magnetic field produced by the vehicle while operating, (iii) generating the image of the spatial distribution of the magnetic anomalies across the area of the scene to be mapped, or (iv) combination thereof, either in real time (that is, while the vehicle is operating) or in post-processing. In at least one specific case, the image produced by the programmable electronic circuitry is a visually-perceivable image. Alternatively or in addition—and substantially in every implementation of the apparatus—the programmable electronic circuitry may be configured to carry out the process of compensating the geometrically corrected ambient magnetic field with a corrective magnetic field based on data that represent weights corresponding to the vehicle operational parameters (Here, the weights have been determined with a model trained on first training data acquired during operation of the vehicle under operating conditions that substantially exclude or avoid or prevent sensing of the magnetic anomalies by the set of the magnetic sensors). Optionally, in the specific case of such configuration, the operating conditions may include operating the vehicle at an auxiliary scene that is substantially devoid of the magnetic anomalies or operating the vehicle above the scene to be mapped at a separation from the scene to be mapped that causes a signal at the magnetic sensors, generated by the magnetic anomalies of the scene to be mapped, to be substantially reduced in magnitude (for example, to be substantially below a detectable level required to obtain training data to estimate weights.)

Embodiments of the invention additionally provide a method that includes (i) measuring a plurality of vehicle operational parameters; (ii) determining a plurality of parameters of a vehicle magnetic field corrective model based on the measured plurality of vehicle operational parameters; (iii) measuring a vehicle environment magnetic field; (iv) identifying a plurality of vehicle magnetic fields corrective models based on the plurality of parameters of the vehicle magnetic field corrective model; and (v) selecting a vehicle magnetic field corrective model based on the vehicle environment magnetic field. At least one implementation of the method may include determining a corrected vehicle magnetic field by applying the vehicle magnetic field corrective model to the vehicle environment magnetic field (and, optionally, a step of calculating a magnetic field invariant map of a target area based on the corrected vehicle magnetic field; and further optionally, a step of detecting an object buried at the scene based on the magnetic field invariant map). In at least one implementation of the method, the plurality of the vehicle operational parameters may include a rotational speed of an electric motor of the vehicle and a power bus current. Optionally, the plurality of the parameters of the vehicle magnetic field corrective model includes the plurality of the vehicle operational parameters, a plurality of time derivatives of such vehicle operational measurements, and phase characteristics associated with the vehicle operational parameters. It is appreciated that substantially every embodiment of the method may be configured to be performed with an embodiment of the vehicle-based apparatus alluded to above.

Embodiments further provide a method for identifying magnetic anomalies at a scene to be mapped. Such method includes the following steps (carried out for each location of the vehicle moving above the scene to be mapped, with the vehicle carrying a magnetometer system that contains a set of magnetic sensors attached to the vehicle and a vehicle sensor system at least electrically coupled with an operational component of the vehicle): (i) a step of determining a local magnetic field produced by the moving vehicle at a location, an altitude, and an orientation of the vehicle based at least one a plurality of operational parameters of the vehicle measured with the vehicle sensor system during the moving above the scene to be mapped and corresponding weight (weight values) generated with a model trained on training magnetic field data acquired from the set of magnetic sensors; and (ii) a step of forming an image, of a spatial distribution of said magnetic anomalies across the scene to be mapped, in which an image noise is reduced by an amount corresponding to said local magnetic field. A method may also includes a step of transforming first parameters representing an ambient magnetic field at the location and the altitude of the vehicle to second parameters of a geometrically corrected ambient magnetic field that is dependent on the orientation of the moving vehicle at the location and the altitude. In at least one embodiment of the method, the first parameters of the ambient magnetic field, the second parameters of the geometrically corrected ambient magnetic field, and third parameters of the local magnetic field produced by the vehicle are Cartesian components of respectively corresponding magnetic fields. In at least one embodiment, the step of transforming may include (1) identifying first values of latitude, longitude, and elevation associated with the location and (2) projecting, onto a plane of the vehicle, the first values using a direction cosine matrix derived from yaw, pitch, and roll data representing an orientation of the vehicle. Alternatively or in addition, an embodiment of the method may include adjusting such first values to obtain second values of latitude, longitude, and elevation associated with locations of sensors of the set of sensors based on measured separations and orientations of the sensors with respect to a reference point at the vehicle. Alternatively or in addition, an embodiment of the method may include a step of generating the weight values by minimizing a difference between (a) a first magnetic field predicted by the model with the use of telemetry system data and data representing a geometrically corrected ambient magnetic field that is dependent on the orientation of the moving vehicle at the location and the altitude; and (b) the training magnetic field data. Optionally, substantially every implementation of the method may additionally include a step of determining the local magnetic field by (a) using a time-dependent current draw of an electric motor present at the vehicle, a time-dependent rotational speed of the motor, a first operational characteristic derived from the time-dependent current draw and representing a phase delay associated with non-uniformities of the operation of the motor, and a second operational characteristic derived from the time dependent rotational speed and representing a phase delay between telemetry data and said local magnetic field; or (b) using the time derivative of the time-dependent current draw, the time derivative of the time-dependent rotational speed, the first operational characteristic, and the second operational characteristic; or (c) using the time-dependent current draw of an electric motor present at the vehicle, the time-dependent rotational speed of said motor, a time derivative of the time-dependent current draw, a time derivative of the time-dependent rotational speed, the first operational characteristic, and the second operational characteristic. The step of determining the local magnetic field may include determining the local magnetic field produced by the vehicle in real time with measuring the plurality of operational parameters of the vehicle during the moving. Alternatively or in addition, an embodiment of the method may include a step of increasing sensitivity of detecting of magnetic anomalies by at least rigidly attaching the set of magnetic sensors to the vehicle to prevent the magnetic sensors from moving with respect to the vehicle; and/or the step of determining the local magnetic field produced by the vehicle may include determining the characteristics of both in-phase and phase-lagged components of the local magnetic field based at least on a time-dependent rotational speed of an electric motor present at the vehicle and a time-dependent current draw of such electric motor and chosen functions of the rotational speed and the current draw. Alternatively or in addition—and substantially in every implementation—the method may include increasing a signal to noise ratio, associated with detecting of magnetic anomalies (in one specific case—by at least five orders of magnitude) as compared with that of a process of detecting the magnetic anomalies at the scene to be mapped with the use of the same vehicle in absence of the step of determining the local magnetic field; and/or a step of acquiring the training magnetic field data with the set of magnetic sensors during operation of the vehicle under conditions that exclude or avoid or prevent sensing of the magnetic anomalies of the scene to be mapped with the set of magnetic sensors.

### BRIEF DESCRIPTION OF THE DRAWINGS

The invention will be more fully understood by referring to the following Detailed Description of Specific Embodiments in conjunction with the Drawings, of which:

FIG. 1 Illustrates sources of magnetic field at a location of a drone. a: current draw from DC power bus to motors; b: Earth's ambient magnetic field; c: vibration of the platform; d: motion of permanent magnets inside the motors; e: payload instrumentation.

FIG. 2: Magnetic noise reduction process workflow.

FIG. 3A schematically illustrates a field containing inert sources of magnetic anomalies (targets), used for validation of the noise reduction methodology and associated data processing.

FIG. 3B presents specifications of the targets. Abbreviations: D (diameter), H (height), L (length), W (width), AT (anti-tank), AP (anti-personnel), IED (improvised explosive device), EM (electromagnetic), PDM (pursuit deterrent munition).

FIGS. 4A and 4B demonstrate comparison between unfiltered collected data and 0.25 Hz low-pass filtered collected data. The filtered data have better spatial coherence as filtering suppresses vibration from the operating (moving) vehicle.

FIG. 5 includes three bar plots and presents weight coefficients for Model A. Input data and model variables have been normalized to std=1. The four magnetometers of the used TetraMag magnetometer are identified with labels “Mag1”, “Mag2”, “Mag3”, “Mag4”.

FIG. 6 includes three bar plots and presents weight coefficients for Model B. Input data and model variables have been normalized to std=1. The four magnetometers of the used TetraMag magnetometer are identified with labels “Mag1”, “Mag2”, “Mag3”, “Mag4”.

FIG. 7 includes three bar plots and presents weight coefficients for Model C. Input data and model variables have been normalized to std=1. The four magnetometers of the used TetraMag magnetometer are identified with labels “Mag1”, “Mag2”, “Mag3”, “Mag4”.

FIGS. 8A, 8B, 8C, and 8D present the summary of performance of the considered embodiments of the model. FIG. 8A illustrates the root mean squared error for each Cartesian component by the model. “Exp B” (˜B^{exp}) uses only the geometrically compensated (geometrically corrected) values. FIG. 8B shows an example of a signal obtained from Magnetometer 4, z-component (CB_{4Z}), with the values predicted by Model C. FIG. 8C illustrates the magnetic field signal representing anomalies produced by the Model C. The value of the signal match the expected anomaly ranges for landmines, UXO, and ERW. FIG. 8D shows predicted B_{4Z} vs measured B_{4Z}. The straight line 808 is a 1:1 reference.

FIG. 8E: Summary of average order of magnitude variance reduction by component of magnetic field for each of the considered embodiments of the model.

FIG. 8F: Root Mean Squared Error (RMSE) amplitude between different components of G using both uncorrected and corrected TetraMag data for each of the considered embodiments of the model.

FIG. 9. Average Bx, By, and Bz components of magnetic fields produced by the small-scale anomalies by magnetic noise model, with target locations indicated. A black “+” symbol indicates GNSS locations of ferrous and possibly ferrous targets (compare with FIG. 3A). A black “∘” symbol indicates GNSS locations of non-ferrous targets and control holes.

FIG. 10 includes plots illustrating comparison of noise-reduced data with object locations using the determinant of the symmetric part of the full magnetic gradient tensor (|GS|). A black “+” symbol indicates GNSS locations of ferrous and possibly ferrous targets. A black “∘” symbol indicates GNSS locations of non-ferrous targets and control holes.

FIG. 11 illustrates a signal error produced as the percentage of expected magnetic anomaly for a metal AT mine buried at a depth of 15 cm, measure with a triaxial magnetometer from 0.5 m height, as a function of the uncertainty that arises from the yaw pointing error (in degrees) of the sensor. Here, B_{X}=150 nT, B_{Y}=200 nT, B_{Z}=400 nT, declination=−10.5 degrees, inclination=67.12 degrees. Very small pointing errors produce spurious magnetic signals large enough to obscure those produced by the AT mine, thereby increasing the chances misidentification of the sought-after target (magnetic anomaly).

FIG. 12 illustrates an example of a method for determining a vehicle magnetic field corrective model.

FIG. 13 illustrates an example of a method for reduction of the vehicle magnetic self-noise to generate a magnetic field invariant map.

FIG. 14 is a schematic illustrating a vehicle equipped with magnetic sensors.

Generally, like elements or components in different Drawings may be referenced by like numerals or labels and/or the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

It does not come as a surprise that challenges arise from unwanted magnetic noise generated by DC motors and power systems of the operating vehicle itself, which magnetic noise can—and does—obfuscate magnetic signals of interest from magnetic anomalies distributed across the surveyed scene (such as, for example, those from buried utilities, unexploded ordnance (UXO), landmines, or explosive remnants of war, to name just a few). The ever-present self-noise environment begs a question of how to configure the vehicle-based measurement of the distribution of a magnetic field across the scene of interest to obtain true, sought-after data in which the magnetic signature of the vehicle is at least reduced.

In accordance with embodiments of the present invention, methods and apparatus are disclosed for compensation of the presence of the local magnetic field(s) that are generated by the scene-surveying magnetometer-equipped vehicle and that perform as magnetic self-noise (which masks the very presence and spatial distribution of magnetic anomalies across the scene that are being measured).

In particular, a methodology to correct vehicle-generated magnetic noise is implemented and validated, thereby enabling the detection of small-scale magnetic anomalies present at the target area (ground, scene) due to compensation of the magnetic noise that would otherwise mask the presence of such anomalies. The use of the method is illustrated with the specific examples of using vehicle operational data (in one case—telemetry data) acquired from a drone containing the Freefly Alta X vehicle sensor system (in one case—telemetry system) at a ground or scene that contains inert “mines” or “targets” to build a model of the expected spatial distribution of the magnetic field across such ground or scene for a rigidly-mounted to the drone triaxial magnetic gradiometer (TetraMag). (However, it is explicitly noted that implementations of the invention are not limited to the use of a drone but, instead, are compatible with and applicable to any type of a vehicle—that is, to any type of means of carrying or transporting people or various goods such as electronic equipment, for example, whether underground, on land, water, air, or space—and thus remain within the scope of the invention.) The discussed model is based on the instantaneous position/orientation of the vehicle and operational characteristics of the vehicle recorded with the vehicle sensor system (such as, for example, a telemetry system), and is presented below with a specific example of the operational characteristic that include, for example, current drawn from each battery through power controls to each motor present at the vehicle, motor speed, and locations of magnetometers locations. (It would be appreciated by a skilled person that, generally, the described methodology is applicable both in real-time and through post processing of the data collected by the sensors of the vehicle, so the telemetry system represents but one example of the vehicle sensor system configured to collect operational parameters or characteristics of the vehicle. The term “current draw from a motor” or similar terms when used are intended to denote and are defined as “current or currents across the power bus of the vehicle, such as, for example, current supplying motors and other systems, power bus current(s).”) The expected magnetic field strengths predicted by the model are subtracted from the measured signals at each magnetometer location, thus compensating the empirically acquired magnetic field data for the magnetic self-noise of the vehicle. Notably, the relative variance reductions achieved on the Bx, By and Bz components of the magnetic field were demonstrated to be of 99%, 97%, and 99.9%, respectively. The demonstrated correction of the ambient magnetic field (the Earth's magnetic field) at the location of the vehicle and correction and reduction of the ever-present magnetic signature of the vehicle improves the detection fidelity and enables higher-resolution localization of magnetic targets (which are interchangeably referred to herein as magnetic anomalies).

### I. Examples of Sources of Magnetic Self-Noise

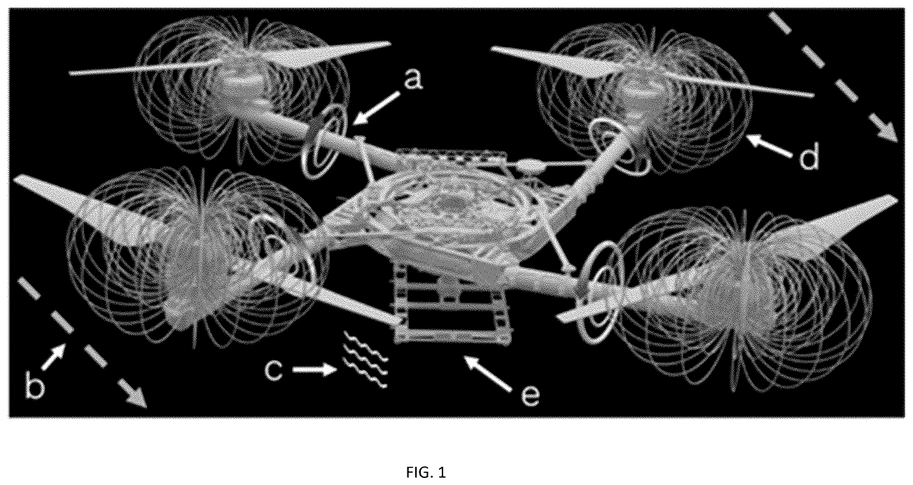

Magnetic self-noise sources of a vehicle include fields induced by current drawn from DC motors, motions of permanent magnets inside the motors, vibration, vehicle attitude/orientation with respect to the Earth's magnetic field, vehicle's actual location, currents induced by moving through spatially-varying magnetic fields, and any payload instrumentation that is being carried by the vehicle. FIG. 1 schematically illustrates these magnetic-noise sources in the specific non-limiting example of the Freefly Alta X platform. Owing to Ampere's Law, DC brushless motors (BLDC) aboard the Alta X generate magnetic signatures with amplitude proportional to the current drawn from the DC power bus to each motor (labeled a in FIG. 1). The motion of permanent magnets inside the BLDC motors produces time-varying magnetic fields, and any conductive or ferromagnetic vehicle components moving through the ambient field also produce magnetic fields (via Faraday's induction or magnetization), resulting in additional magnetic self-noise (see label din FIG. 1). Payload instrumentation, labeled e in FIG. 1, may also contribute magnetic noise depending on specifications. Triaxial magnetometers (used in the example of FIG. 1) measure components of the magnetic field aligned along the axis of a core of each of the magnetometers, so Earth's ambient magnetic field is sampled as the projection of such magnetic field onto the axis of each component (indicated with the label b in FIG. 1). Notably, for a rigidly mounted magnetometer system, a change in orientation of a given sensor on the order of a microradian and changes in the vehicle attitude (i.e., yaw, pitch, and roll) generates detectable spurious magnetic signals or suppress desired magnetic signals, thereby contributing to total vehicle self-noise (see H. Myers, et al., Geophysics, v. 90, No. 4, pp. G93-G108, 2025).

Structural vibrations (including twisting and bending modes of the vehicle) can change the relative positioning and orientation between the vehicle and individual magnetometer components, introducing yet another source of noise. The vehicle platform vibrations can also occur faster and/or at a higher frequency than the ability of onboard magnetic sensors to measure and compensate for the magnetic noise generated due to such vibrations, thus further introducing noise in collected data (label c).

### II. Brief Description of a Magnetic Noise Reduction Methodology

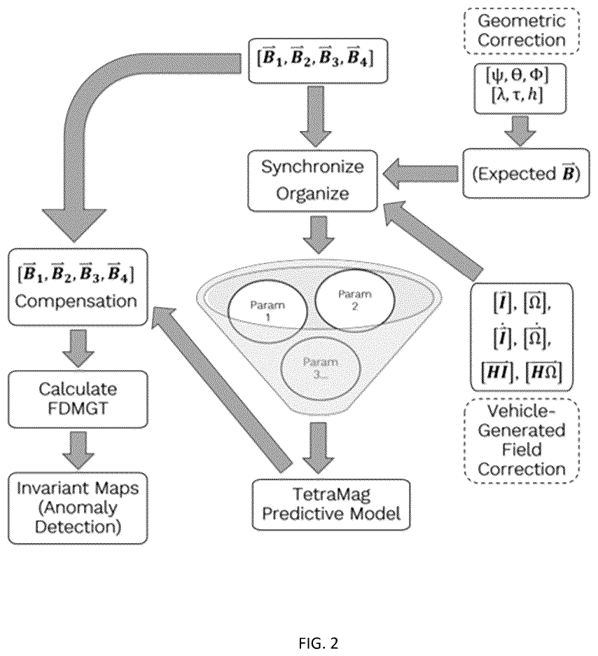

FIG. 2 illustrates schematically the workflow for an embodiment of the methodology for the magnetic noise reduction structured according to the idea of the invention, the finite difference magnetic scalar, magnetic vector, or magnetic gradient tensor calculation or higher order derivatives such as the Hessian, and the construction of images of detected targets—which in this case is images of spatial distribution of magnetic anomalies across the area of the scene to be mapped (the anomaly maps). In one implementation, readings of magnetic field by magnetic sensors (magnetometers) of the TetraMag system were collected using a dedicated Raspberry Pi 4 microcontroller with a real-time clock. At the same time, the vehicle operational data collected by the vehicle sensor system—the Alta X logs, in one specific example—were collected using the embedded Black Cube microcontroller, with timestamps from real-time kinematic (RTK) GNSS data.

One example of the process flow begins with data preparation (described below), including calibration of the magnetometer system (TetraMag) data, synchronization with vehicle operational data, and downsampling to 4 Hz to match the sampling frequency of the MEDA FVM400 magnetometer sensors used to construct the TetraMag. The vehicle operational data measured by the vehicle sensor system (Alta X in one example) is leveraged to construct the TetraMag predictive model. Notably, since the essence of the proposed methodology is defined by considering only the total contribution from the combined magnetic noise sources, multiple potentially useful parameters such as vehicle operational parameters describing the status of the operating (moving) vehicle could help capture information about such combined magnetic field signal, including (but not necessarily limited to) i) GNSS or GPS Position of the vehicle: latitude (λ), longitude (τ); ii) Altimeter Elevation (h) of the vehicle; iii) Vehicle Attitude, including yaw (ψ), pitch (θ), and roll (φ); and the parameters of vehicle's operation such as, for example, iv) Motor Current Draw or Power Bus Current (\vec{I}); v) Motor Speed: RPM (\vec{Ω}). (The vehicle operational parameters can additionally or in the alternative include date, time, altitude, barometric pressure, temperature, ground speed, vertical speed, linear and/or rotational accelerations, for example.)

The candidate models (which may include linear regression models presented as non-limited examples in the discussion below, or non-linear models, whether machine learning models or standard statistical inference of inverse theory techniques) using parameters are then trained from the vehicle operational parameters dataset described below.

### A. Expected Ambient Magnetic Field (B^{exp}) at the Location/Orientation of the Vehicle.

In further reference to FIG. 2, the information of latitude, longitude, elevation, and attitude/orientation of the vehicle was combined with the known locations of the individual magnetic sensors of the set of magnetic sensors of the TetraMag magnetometer system to take a step towards calculation of the values of the magnetic field (Bx, By, and Bz values) for each of the i^{th} sensor of the set (in this example, i=1, 2, 3, 4) that make up the Cartesian components of the vector magnetic field B^{exp} that the vehicle is expected to be exposed to at its location and spatial orientation.

Initially, a query to the world magnetic model (WMM) for Bx, By, and Bz values of the Earth magnetic field (the background, ambient magnetic field at the vehicle's measured latitude, longitude, and elevation) is made. Each sensor's position is corrected for the known separation and the position of the vehicle's attitude sensor before querying the WMM for that sensor. Precise elevation (1 cm resolution) is obtained with the use of an optoelectronic system (In one specific example, such optoelectronic system may be represented by a vehicle-locating system such as a laser Doppler system, a radiofrequency Doppler system, an acoustic Doppler system, radar, sonar, LiDAR, or for example an externally integrated laser rangefinder. Due to ground effects impacting barometer stability, such system provides more reliable altitude measurements for the very low-altitude (<1 m) movements of the vehicle than those provided by the Alta X's combination of the IST8310 magnetometer and the BMP388 barometer.) Thereafter, the parameters of yaw, pitch, and roll logged with the vehicle sensor system of the vehicle (which may be an inertial measurement unit known in related art as an IMU, which is an electronic system configured to measure and reports a body's specific force, angular rate, and sometimes the orientation of the body, using at least a combination of accelerometers and gyroscopes) are used to construct the direction cosines (coordinate rotation) matrix and project the ambient expected field onto the plane of the drone, thus producing the parameters of (the vector of the) expected ambient magnetic field B^{exp}—or what is referred to herein interchangeably as a geometrically corrected ambient magnetic field.

### B. Motor Current Draw, Speed as Operational Parameters of the Vehicle and Corresponding Corrective Parameters.

Referring again to the schematic of FIG. 2, as is well recognized, DC motors convert current and voltage into mechanical motion (and heat). The functioning of a DC motor can be generally described by two governing equations: the time rate of change of the conservation of energy (power) and the motor's voltage balance equation. The power balance equation can be written as

$$IV = {I}^{2} R + τ Ω \qquad ( 1 )$$

where I is current, V is the voltage applied to the motor, R is the resistance that comes from the motor's armature, τ is torque, and Ω is the angular speed at which the rotor of the motor rotates. The motor voltage balance equation can be written as follows:

$$V = IR + L \dot{I} + {V}_{EMF} \qquad ( 2 )$$

where L is motor inductance, İ is the rate of change (i.e. time derivative) of current, and V_{EMF} is the back electromotive force (EMF), which is associated with the work the DC motor produces to convert electrical energy to mechanical energy or vice versa. The motor current draw, the vector value \vec{I}=(I₁, I₂, I₃, I₄), is measured for the four motors aboard the vehicle via its built-in vehicle sensor system. Each motor is electrically wired to a central power distribution unit, so the magnetic field generated around each of these wires as the motor draws current from the central batteries is expected to approximately follow the Biot-Savart Law

$$\vec{B} ( \vec{r} ) = \frac{{μ}_{0}}{4 π} {\int }_{C} \frac{Id \vec{l} \times {\vec{r}}^{′}}{{\vert {\vec{r}}^{′} \vert}^{3}} \qquad ( 3 )$$

where C is the path of the current-carrying wires and d\vec{l} is the differential length along the path in the direction of the current flow, \vec{r′}=r−l is the full displacement vector from the measurement point r to a point along the wire, and μ₀ is the permeability of free space.

By considering \vec{I} as the operational parameter of the moving vehicle, the conservation of energy of the vehicle motors and torque are taken into account (since the current is directly proportional to torque). Optionally, the time derivative of the current, \vec{İ}, may be considered as well as it accounts for the voltage balance of the vehicle's motor. To capture information about any potential phase delays associated with non-uniformities of the operation of the motor, the imaginary part of the analytic signal of the current (i.e., via Hilbert transform of each motor's current measurement, \vec{HI}), may be considered alternatively or in addition, as a vehicle magnetic field corrective model parameter.

Similarly to the current draw, another parameter of the vehicle's operation—the motor rotational (angular) speed, \vec{Ω}, considered for all of the motors present at the vehicle (in the considered case—four: \vec{Ω}=(Ω₁, Ω₂, Ω₃, Ω₄)), can be measured with the vehicle's sensor system to account, in the proposed model, for both the back EMF and energy conservation. (Indeed, a motor may be considered to be in series with a resistor, and as the current draw increases, V_{EMF} increases as well, substantially proportionately to Ω.) Another alternative or additionally corrective operational parameter to be considered as part of the proposed model may be the time-derivative of the motor rotational speed \vec{\dot{Ω}}, to account for the possibility that the vehicle is not necessarily moving at be moving at a constant velocity (thereby more precisely considering Eddy currents in the motors that arise via Faraday induction). Yet another example of the optional corrective operating parameter may be one ensuring the inclusion of a potential phase delay information—which in one case may be the Hilbert transform of each motor's rotational speed, \vec{HΩ}.

### C. Examples of Embodiments of the Magnetic Self-Noise Reduction Model.

In accord with the examples of considerations for the operational parameters of the vehicle presented above, three separate embodiments of the magnetic self-noise reduction model were constructed to explore the extent to which different combinations of the vehicle's sensor data and vehicle operational parameters would be useful in predicting magnetic self-noise noise generated by the operating (moving) vehicle.
Model A included the use of

$${\vec{B}}_{i}^{exp} ,$$

### \vec{I}, \vec{Ω}, \vec{HI}, and \vec{HΩ}:

$$[ \begin{matrix}{\vec{B}}_{1}^{Exp} ( t ) \\ {\vec{B}}_{2}^{Exp} ( t ) \\ {\vec{B}}_{3}^{Exp} ( t ) \\ {\vec{B}}_{4}^{Exp} ( t )\end{matrix} ] + [ \begin{matrix}\vec{{a}_{1}} & \vec{{b}_{1}} & \vec{{c}_{1}} & \vec{{d}_{1}} \\ \vec{{a}_{2}} & \vec{{b}_{2}} & \vec{{c}_{2}} & \vec{{d}_{2}} \\ \vec{{a}_{3}} & \vec{{b}_{3}} & \vec{{c}_{3}} & \vec{{d}_{3}} \\ \vec{{a}_{4}} & \vec{{b}_{4}} & \vec{{c}_{4}} & \vec{{d}_{4}}\end{matrix} ] [ \begin{matrix}\vec{I} ( t ) \\ \vec{Ω} ( t ) \\ \vec{HI} ( t ) \\ \vec{HΩ} ( t )\end{matrix} ] = [ \begin{matrix}{}^{A} {\vec{B}}_{1} ( t ) \\ {}^{A} {\vec{B}}_{2} ( t ) \\ {}^{A} {\vec{B}}_{3} ( t ) \\ {}^{A} {\vec{B}}_{4} ( t )\end{matrix} ] \qquad ( 4 )$$

Here, A\vec{B}ᵢ(t) is Model A's predicted magnetic field for each of the magnetometer sensors at time t,

$${\vec{B}}_{i}^{Exp} ( t )$$

is the set of the expected magnetic field values for each of the magnetometer sensors from the set of magnetometer sensors (i=1, 2, 3, 4) at time t, the matrix with parameters a, b, c, d represents the model parameters or coefficients that scale each of the vehicle's operational variable (related to time-dependent current drawn by the motors and rotational speed of the motors).
Model B: included the use of

$${\vec{B}}_{i}^{exp} ,$$

### \vec{I}, \vec{\dot{Ω}}, \vec{HI} and \vec{HΩ}:

$$[ \begin{matrix}{\vec{B}}_{1}^{Exp} ( t ) \\ {\vec{B}}_{2}^{Exp} ( t ) \\ {\vec{B}}_{3}^{Exp} ( t ) \\ {\vec{B}}_{4}^{Exp} ( t )\end{matrix} ] + [ \begin{matrix}\vec{{a}_{1}} & \vec{{b}_{1}} & \vec{{c}_{1}} & \vec{{d}_{1}} \\ \vec{{a}_{2}} & \vec{{b}_{2}} & \vec{{c}_{2}} & \vec{{d}_{2}} \\ \vec{{a}_{3}} & \vec{{b}_{3}} & \vec{{c}_{3}} & \vec{{d}_{3}} \\ \vec{{a}_{4}} & \vec{{b}_{4}} & \vec{{c}_{4}} & \vec{{d}_{4}}\end{matrix} ] [ \begin{matrix}\vec{I} ( t ) \\ \vec{Ω} ( t ) \\ \vec{HI} ( t ) \\ \vec{H Ω} ( t )\end{matrix} ] = [ \begin{matrix}{}^{B} {\vec{B}}_{1} ( t ) \\ {}^{B} {\vec{B}}_{2} ( t ) \\ {}^{B} {\vec{B}}_{3} ( t ) \\ {}^{B} {\vec{B}}_{4} ( t )\end{matrix} ] \qquad ( 5 )$$

Here, B\vec{B}ᵢ(t) is Model B's predicted magnetic field for each of the magnetometer sensors at time t, and the rest of the parameters have been already defined above.
Model C: included the use of

$${\vec{B}}_{i}^{exp} ,$$

### \vec{I}, \vec{İ}, \vec{Ω}, \vec{\dot{Ω}}, \vec{HI} and \vec{HΩ}:

$$[ \begin{matrix}{\vec{B}}_{1}^{Exp} ( t ) \\ {\vec{B}}_{2}^{Exp} ( t ) \\ {\vec{B}}_{3}^{Exp} ( t ) \\ {\vec{B}}_{4}^{Exp} ( t )\end{matrix} ] + [ \begin{matrix}\vec{{a}_{1}} & \vec{{b}_{1}} & \vec{{c}_{1}} & \vec{{d}_{1}} & \vec{{e}_{1}} & \vec{{f}_{1}} \\ \vec{{a}_{2}} & \vec{{b}_{2}} & \vec{{c}_{2}} & \vec{{d}_{2}} & \vec{{e}_{2}} & \vec{{f}_{2}} \\ \vec{{a}_{3}} & \vec{{b}_{3}} & \vec{{c}_{3}} & \vec{{d}_{3}} & \vec{{e}_{3}} & \vec{{f}_{3}} \\ \vec{{a}_{4}} & \vec{{b}_{4}} & \vec{{c}_{4}} & \vec{{d}_{4}} & \vec{{e}_{4}} & \vec{{f}_{4}}\end{matrix} ] [ \begin{matrix}\vec{I} ( t ) \\ \vec{Ω} ( t ) \\ \dot{\vec{I}} ( t ) \\ \dot{\vec{Ω}} ( t ) \\ \vec{HI} ( t ) \\ \vec{H Ω} ( t )\end{matrix} ] = [ \begin{matrix}{}^{C} {\vec{B}}_{1} ( t ) \\ {}^{C} {\vec{B}}_{2} ( t ) \\ {}^{C} {\vec{B}}_{3} ( t ) \\ {}^{C} {\vec{B}}_{4} ( t )\end{matrix} ] \qquad ( 6 )$$

Here, C\vec{B}ᵢ(t) is Model C's predicted magnetic field for each of the magnetometer sensors at time t, the matrix with parameters a, b, c, d, e, f represents the model parameters or coefficients that scale each of the vehicle's operational variable (related to time-dependent current drawn by the motors and rotational speed of the motors), and the rest of the parameters have been already defined above.

The performance of each of these model embodiments was tested using data collected at the predetermined scene (described below). In all cases, the model parameters or coefficients were assumed to be time-invariant, and were allowed to be different for each component and each magnetometer sensor (the model parameters are denoted as vector quantities with a subscript that identifies the magnetometer sensor and a directional component that refers to the components of the vector magnetometers of the used TetraMag).

### III. Field Data

This section describes the field area (scene) used to both accomplish the preparation steps required to train several embodiments of the magnetic self-noise reduction mode and to validate the magnetic noise reduction efficiency and the data processing steps of such embodiments.

### A. Survey Area (Scene to be Mapped)

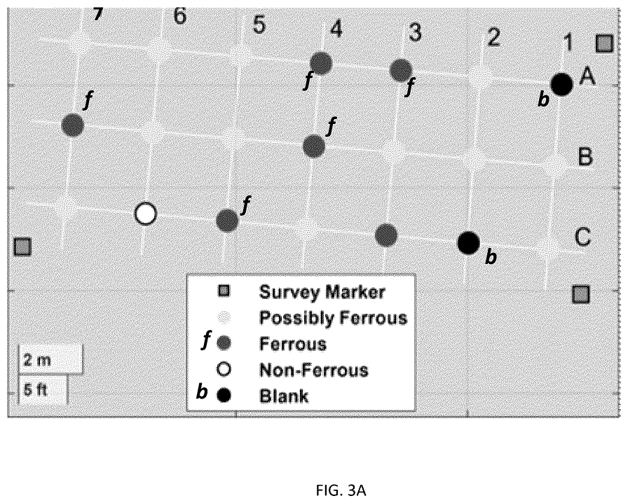

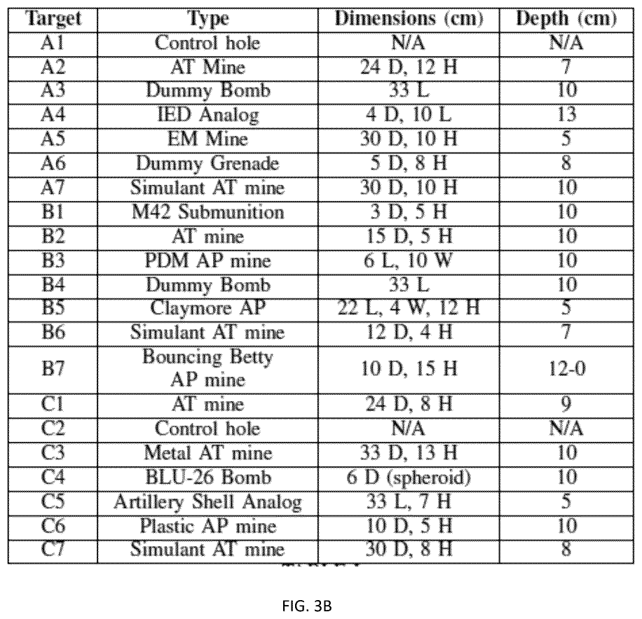

The approximately 17.5 m×7.5 m survey area was assembled using a collection of “targets” (including inert landmines and cluster munitions) at realistic depths for their typical deployment. FIG. 3A illustrates the survey layout, with row labels A, B, and C, and column labels 1-7. Targets include those known to be ferrous (marked as “f”), non-ferrous, blank control holes (marked as “b”), and the remaining target as possibly ferrous ones. FIG. 3B summarizes a description of each target, with dimensions and burial depths.

### B. Preparational Steps for Training of an Embodiment of the Model.

### (B1) General Considerations.

As the skilled person will appreciate, in general an embodiment of a magnetic noise reduction model has a potentially non-linear dependence on the vector of vehicle sensor data. In order to gather the sensor data necessary for constructing an accurate noise reduction model, a vehicle path is needed that samples substantially all of the directions of the sensor data. Additionally, to achieve accuracy of a given embodiment of the model, this may require gathering observations that allow estimation of nonlinear terms that are functions of pairs, triplets, etc. of sensor parameters slewing as well (i.e. pitching while yawing, while rolling, etc.)

One efficient way of accomplishing such data sampling could be by conducting an n-simplex search associated with the dimensions of the available vehicle sensor system that can be traversed by the vehicle (in air, on ground, on sea surface, underwater). Such search would be optimal when there are necessary edges or curves on the path of the moving vehicle. For example, if there were only three vehicle sensors, traversing a tetrahedron (3-simplex) during a vehicle path would sample all of the sensor data needed for both linear and nonlinear noise reduction models. The tetrahedron would ideally be centered on the origin in the sensor space to get both positive and negative motions for each sensor, i.e. yawing left and right, accelerating up and down, etc. Higher dimensional sensor spaces (for example, that including 7 sensors), would require higher dimensional paths in sensor space that could involve n=7 simplexes (the generalization of the tetrahedron to higher dimensions). Polytopes other than simplexes may be used such as other regular polytopes families such as cross-polytopes and hypercubes.

Notably, an embodiment of the model can be produced during training or after training of the vehicle (with the use of the stored training data, using office or cloud computational assets). Optimal coefficients (interchangeably referred to herein as weight coefficients or the vehicle magnetic field corrective model parameters) that define the chosen embodiment of the noise reduction model can be obtained by either standard linear or nonlinear optimization techniques.

### (B2) Non-Limiting Example of Collection of Training Data.

In one specific example, the vehicle (in this case—the drone) was first flown in clover-shaped mission 8 m above the survey area of FIG. 3 to calibrate the magnetic data; thereafter, the least-squares ellipsoid fitting calibration process was applied to the collected training data (see, for example, H. Liu, et al., “An overview of sensing platform technological aspects for vector magnetic measurement: A case study of the application in different scenarios,” Measurement, vol. 187, p. 110352, 2022, the disclosure of which is incorporated by reference herein).

This calibration method allows for correction of measurement inaccuracies caused by the sensor's three axes not being perfectly orthogonal due to fabrication issues and instrument biases. However, the same calibration method does not address the angular uncertainty regarding the magnetometer's orientation in space.

Then the vehicle was flown in a grid pattern survey (N-S and E-W orientations) at 0.5 m altitude with 30 cm spacing between transects across the same field area at 0.5 m/s.

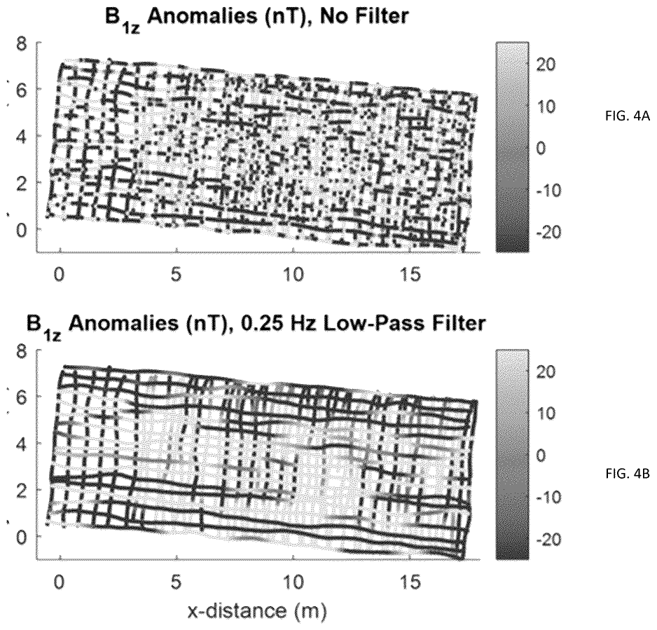

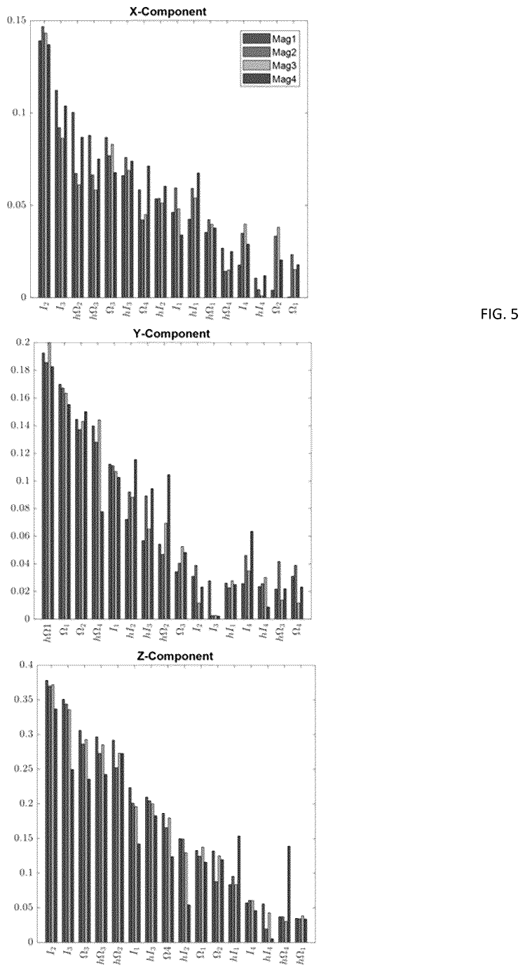

The TetraMag measurements were synchronized with the vehicle sensor data by cross-correlating Alta X's onboard magnetometer with the closest magnetometer sensor that was the closest to the vehicle platform. All vehicle sensor data was additionally downsampled to match TetraMag's sampling frequency (which was about 4 Hz). It was noted that even a rigidly mounted magnetic gradiometer could exhibit vibrational or oscillatory modes that generate additional magnetic noise at specific frequencies. The skilled person will readily appreciate, therefore, that depending on the frequencies of these modes and the sampling frequency of the magnetic sensors present in the system, this noise may need to be corrected. Accordingly, to evaluate the extent to which filtering could be required to suppress vibration-caused magnetic noise from the vehicle, the unfiltered data was compared to a (chosen) 0.25 Hz low-pass filtered version of the same data. FIGS. 4A and 4B demonstrate the examples of the spatial distribution of magnetic anomalies, defined via the z-component of the value of \vec{B} subtracted from the z-component of the \vec{B}^{exp} for one of the magnetometer sensors (here, sensor 1) for the unfiltered case FIG. 4A) and filtered case (FIG. 4B). The results evidence that the spatial coherence increased dramatically once the 0.25 Hz low-pass filter was applied, suggesting that vibrations contribute significantly to the measured data and should be filtered out, especially when small-size, small-amplitude magnetic anomalies are expected. Therefore, in practice the low-pass filter (in this case—the 0.25 Hz low-pass filter) could be applied to both the magnetic sensors' data and the vehicle sensor data before constructing candidate models.

It should be further noted that a low-pass filter limits the maximum survey speed. This is because the low-pass filter can inadvertently filter out small-size anomalies if the vehicle passes over them too quickly to capture them with enough data points. In at least one case of collection of data, this was accounted for by limiting the survey speed to 0.5 m/s, thereby ensuring a nominal spatial resolution of the target anomalies to about 25 cm.

### IV. Weight Coefficients (Parameters) of Embodiments of the Model.

As was already alluded to above, an embodiment of the model (such as Model A, Model B, or Model C identified above as specific non-limiting embodiments) can be produced during training or after training of the vehicle using office or cloud computational assets. Optimal coefficients of a given model can be obtained by standard linear or nonlinear optimization techniques.

According to the idea of the invention, a linear version of the magnetic noise reduction model predicts the combined magnetic signature of the vehicle-generated noise and the ambient magnetic field for a given vehicle's orientation at a vehicle's position. It does so by modeling the expected magnetic fields in a reference (Earth's field) model given the vehicle's orientation together with optimally-weighted sums of the vehicle sensor data. See Eqs. (4), (5), (6) above.

For the case of a linear version of the model, as the skilled person will readily understand, the determination of the optimal model coefficients can be performed as follows. In reference to Eqs. (4), (5), or (6), when schematically denoting the matrix of magnetic data collected by the vehicle's magnetometer system during the training as Bₜᵣₐᵢₙ, the matrix of magnetic field predicted in a given embodiment j of the Model (j=A, B, or C from the examples above) for each of the magnetometers as B_{pred}, the matrix of vehicle sensor data as D, the matrix containing the model-defining coefficients (i.e. the optimal weights a, b, c, d, e, etc) as A, and the matrix containing the geometrically corrected magnetic field (the expected ambient magnetic field at the location and for orientation of the vehicle) as B^{exp}, one could determine A that minimizes (B_{pred}−Bₜᵣₐᵢₙ) in a least-square sense by inverting the linear forward model

$${B}^{exp} - AD = {B}_{pred} - {B}_{train}$$

Alternatively, in practice, the weight coefficients can be determined by simply solving the system of equations using a scheme optimized for precision and speed.

Nonlinear versions of a model are similar to the linear models in that they also yield a predicted magnetic field B_{pred}. Finding the optimized coefficients for a nonlinear model could proceed in a similar fashion, except the vehicle-generated magnetic noise cannot be now expressed as a simple weighted sum of the vehicle sensor inputs. Notably, nonlinear optimization could improve on the accuracy of vehicle self-noise reduction by including both linear estimators as described above and possible coupling terms. Optimal nonlinear models minimize the misfit between the predicted magnetic fields and the observed training magnetic field. Various nonlinear modelling tools could be used on the same vehicle training data described above, including but not limited to SINDY, feed forward neural networks, Ising solvers, model space search approaches, iterative linearization approaches, and quantum computers.

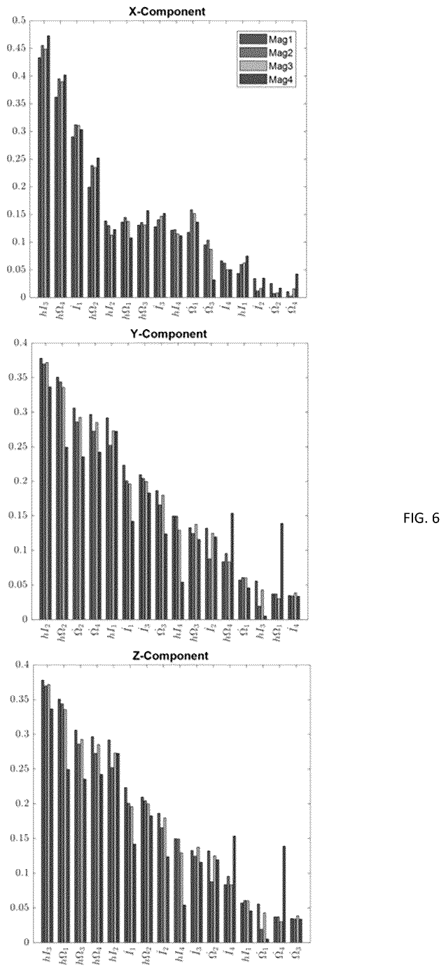

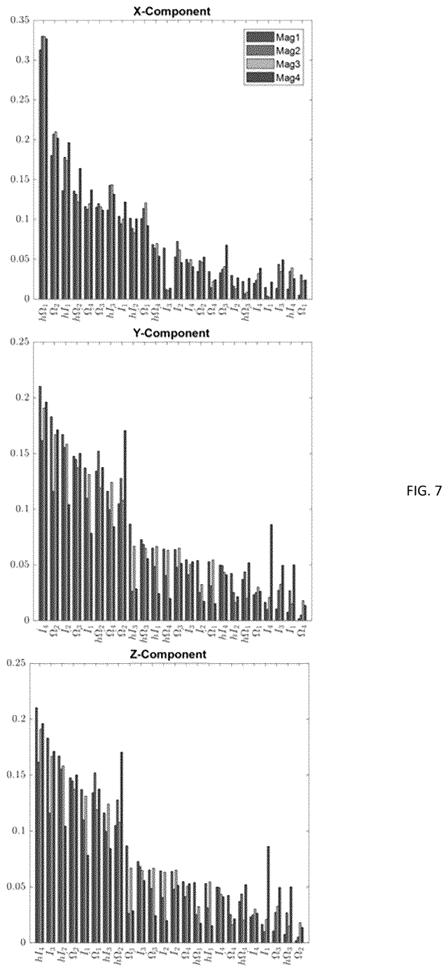

FIG. 5 shows how the amplitudes of Model A's parameters compare, component-by-component, for each magnetometer. FIG. 6 shows how the amplitudes of Model B's parameters compare, component-by-component, for each magnetometer. FIG. 7 shows how the amplitudes of Model C's parameters compare, component-by-component, for each magnetometer. In each of these Figures, individual magnetometers 1 through 4 (B1-B4) are displayed as “Mag1”, “Mag2”, “Mag3”, and “Mag4”, respectively.

### V. Comparison of Performance of Different Embodiments of the Model.

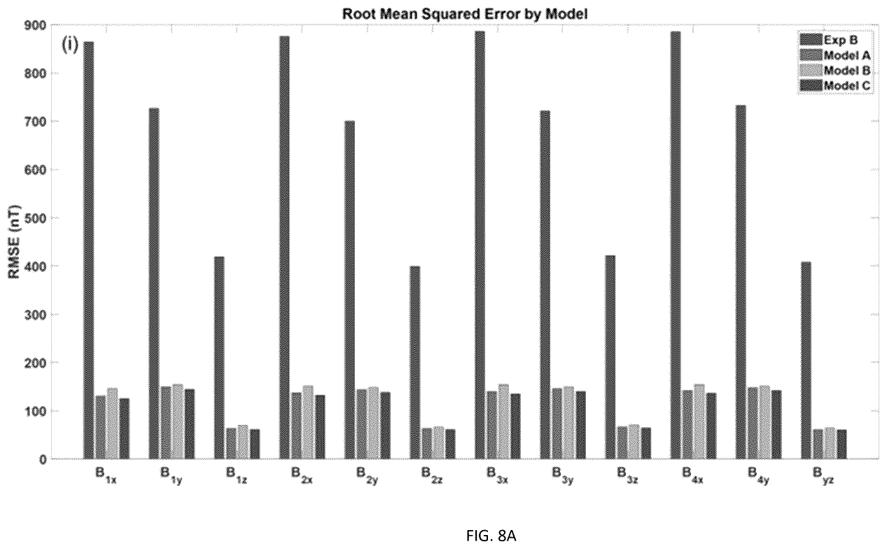

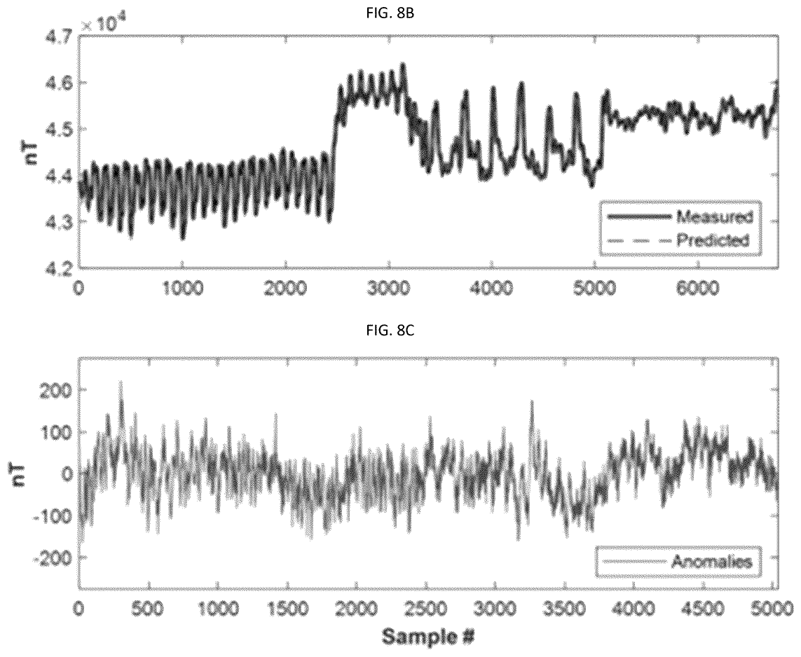

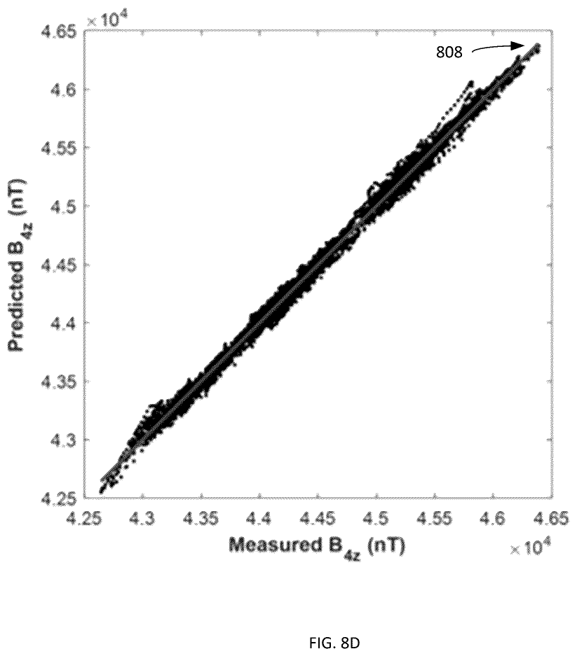

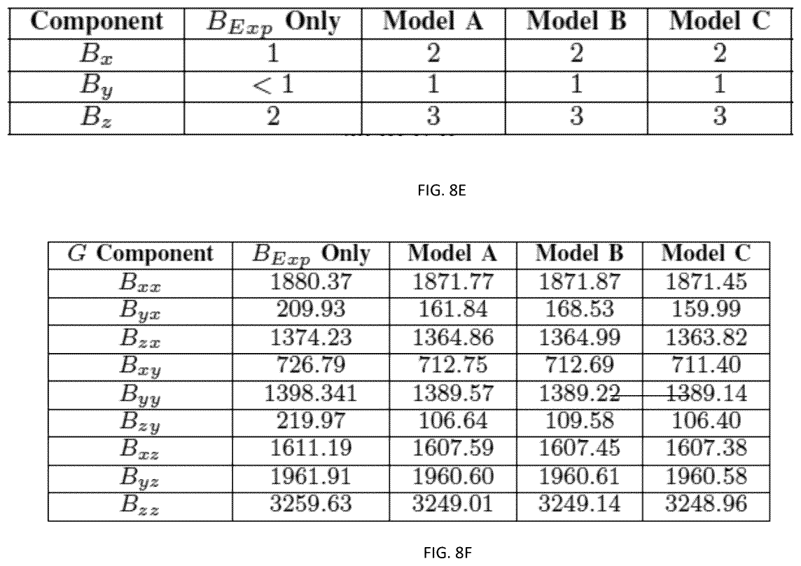

FIGS. 8A, 8B, 8C, 8D, 8E, and 8F quantify each model's performance using the root mean squared (RMSE) error between the model's predicted value of the magnetic field across the area of the chosen scene and the values of the magnetic field measured with the TetraMag system. Here, FIG. 8A illustrates the RMSE by component for the models A, B, and C under the condition that only B^{exp} is included. Unsurprisingly, the largest errors are found for this case, which only accounts for the vehicle's orientation with respect to the world magnetic model but does not incorporate the presence of magnetic self-noise. Model B consistently had higher errors than models A and C, and model C demonstrated the lowest errors across all components of the magnetic field. These results confirm that explicitly accounting for the effects produced by operational components of the vehicle (that is, the components of the vehicle that generate magnetic field(s) when operating—in the considered example, the ones caused by currents \vec{I} drawn by the motos and motor speeds \vec{Ω}), is crucial for successfully modeling vehicle-generated magnetic noise, which is consistent with the conceptual physics-based model outlined above. Z-component predictions are associated with the lowest RMSE values across all embodiments of the model, with CB_{4Z} achieving average RMSE of les than 60 nT. FIG. 8B shows measured B_{4z} values and predicted CB_{4Z} values (which two graphs essentially overlapping one another) for one of the 0.5 m altitude survey flights, with the resulting errors (anomalies) shown in FIG. 8C. Model C recovers the longer periods and the majority of shorter periods from the measured signal. The remaining errors (anomalies) match typical landmine, UXO and ERW anomaly ranges. FIG. 8D is a scatterplot of the predicted CB_{4Z} vs measured B_{4z} values displayed in FIG. 8B, with the one-to-one reference line is marked as 808. As can be seen, the results of Model C predicted values very closely following the 1:1 line, representing a three orders of magnitude of variance reduction. FIG. 8E summarizes the remaining variance reduction estimates. While models A, B, and C all produce the same order of magnitude variance reduction, the smallest values for individual magnetometer components are those corresponding to model C.

Because of the utility of magnetic gradiometry in suppressing natural and cultural magnetic noise and reliably identifying small-amplitude magnetic anomalies, the success of the modelling of the vehicle-generated magnetic noise on the magnetic gradients was also considered. Here, FIG. 8F provides a summary of the root mean-squared error between different components of the finite difference magnetic gradient tensor, G, using both uncorrected and corrected TetraMag data for each model. It can be observed that Model C has the smallest RMSE for all components of G, and models A, B, and C all perform better than the correction of the magnetic field attributed only to including the spatial orientation of the vehicle (B^{exp}).

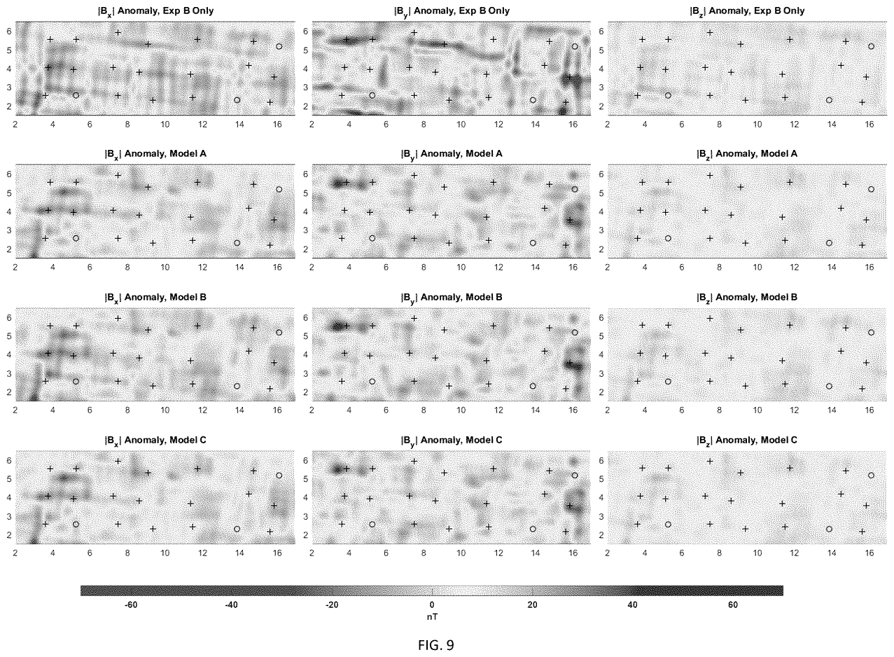

Anomaly Maps. The results of the measurements of magnetic fields may be interpreted by constructing the so-called magnetic anomaly maps that represent or are images of spatial distributions of the magnetic fields in question across the scene to be mapped. To this end, FIG. 9 presents the average Bx, By, and Bz anomaly maps for the field/scene of FIG. 3A containing inert anomalies (various targets, including magnetic targets discussed above) with the known target locations overlaid. Locations of targets that are ferrous or suspected to be ferrous are marked with black crosses, and non-ferrous or control hole locations are those indicated with black circles.

To visualize these data, the observations at each location are fitted using a local cubic B-spline basis on a triangular grid of knots (see, for example, Z. Wang and F. Dahlen, “Spherical-spline parameterization of three dimensional Warth models,” Geophysical Research Letters, vol. 22, no. 22, pp. 3099-3102, 1995). The spacing between knots defining the spline basis was chosen to be 0.25 m, and the best-fit spline coefficients were determined by an L1 misfit damped minimization. The top row of images in FIG. 9 shows the average component maps for orientationally (geometrically) compensated values of the ambient magnetic field (B^{exp}), while rows 2, 3, and 4 of FIG. 9 display maps for models A, B, and C, respectively. Bx, By, and Bz maps constructed from measurements corrected for just the B^{exp} show streaky patterns that cannot be readily attributed to expected magnetic anomalies of the ferrous present at the scene. However, the spatial patterns of maps constructed from magnetic measurements corrected according to the models A, B, and C show dramatically different patterns that are more readily related to and indicate the presence of the weak subsurface targets.

Model C shows the strongest visual agreement across all components. However, model A highlights many of the same features as model C, especially in the x-component. Bz anomalies are smaller than those for Bx and By, but the increase in spatial coherence is still dramatic for models A and C, highlighting areas with small-scale, small-amplitude signals.

The skilled person will readily appreciate that increased prominence of localized anomalies for each average component enables many of the targets to be more accurately located. Still, many of the signals blend together, making it difficult to differentiate them, and some targets do not appear to be associated with a clear magnetic anomaly.

### VI. Discussion

This section analyzes the performance of the selected magnetic self-noise reduction models (corrective models) and their use for characterization of small-amplitude, small-spatial-scale magnetic anomalies. Specifically, the impact of the vehicle's magnetic self-noise on the data fidelity is discussed, followed by the discussion of the practical limitations imposed by the low sampling frequency characterizing the performance of the TetraMag magnetometer system with which the vehicle was equipped in the specific experiments discussed herein.

### A. The Impact of Vehicle's Magnetic Noise on Data Fidelity

As expected, the largest contributing signal measured by magnetometers comes from the Earth's ambient field. Total field magnetometers may be partially compensated by using a base station magnetometer. Still, triaxial magnetometers are sensitive to orientation, so a base station alone is not substantially sufficient for correcting triaxial data, especially on drones. As described above, a more accurate representation of the ambient magnetic field at the location the vehicle may be obtained by projecting the WMM ambient field vectors onto the plane of the vehicle using a direction cosine matrix derived from the vehicle sensor's logged yaw, pitch, and roll data.

FIGS. 8A and 8E show that such correction resulted in 1, <1, and 2 orders of magnitude variance reduction for Bx, By, and Bz, respectively. While this may be sufficient for detecting large-scale anomalies, it is far larger than the expected magnetic signal amplitudes from small-scale anomalies such as landmines, UXO, and ERW. Including the logged current draw, motor speed, as well as their gradients and Hilbert transforms in a linear model with time-independent coefficients facilitates capturing the information about the vehicle's generated magnetic self-noise. At the same time, a low-pass filter helps suppressing some of the signals associated with vibration during flight.

Models A, B, and C have produced substantially the same order of magnitude variance reduction (see FIG. 8F), but Model C produced the lowest RMSE overall. This suggests that the magnetic signals generated by the vehicle have both in-phase and phase-lagged contributions, and that the latter are well-approximated as a phase shift using either the Hilbert transforms or gradients of the current draw, the motor speed, and their gradients.

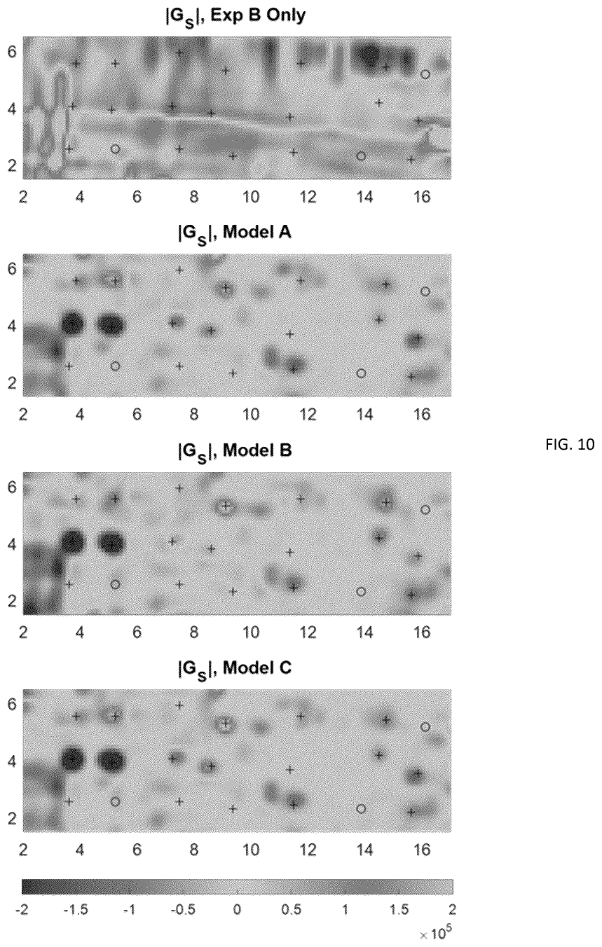

The anomaly maps in FIG. 9 illustrate the spatial variations of the average total magnetic field and individual magnetic field components computed with the use of all four magnetometers of the used TetraMag system. These maps are similar to what one might expect to record using a single triaxial magnetometer. By comparing the patterns of spatial variations before and after the application of the devised noise correction models, one can observe that while the visual agreement increases and magnetic noise is reduced with each of the three proposed models (rows of FIG. 9), not all of the locations of ferrous targets at the scene are immediately apparent. This suggested leveraging invariants derived from the magnetic gradient tensor to visualize the magnetic anomalies. FIG. 10 shows one of the invariants of interest, the determinant of the symmetric part of the magnetic gradient tensor (|GS|) for all models, with the known target locations overlaid. Many spurious signals that obfuscate target locations are apparent when only B^{exp} is used to correct the measured values before computing the gradients. The application of Models A and B dramatically improved the resolution for different sections of the surveyed area. Model C, which incorporates elements from each of the Models A and B, produced the qualitatively least cluttered map, thereby allowing for localization of most targets.

### B. Limitations of Sampling Frequency.

The vehicle's sensors had a sampling frequency of 25 Hz, while the MEDA FVM-400 sensors used by TetraMag in continuous data streaming mode returned data at 4 Hz. While down-sampling the vehicle sensor data to match that from the TetraMag prioritizes the retention of all magnetic data without the risk of introducing spurious signals, the loss of information from the higher-frequency components of vehicle operation understandably impacts both the maximum surveying velocity and the accuracy of yaw, pitch, and roll information included in a given corrective model. High data density is important for all magnetic surveys, but especially so when mapping the presence of small-scale, small-amplitude anomalies. Therefore, to ensure proper data coverage for the small spatial dimensions of the buried targets, the velocity at which the vehicle was moved was limited (in one case to about 0.5 m/s). The slow movement above the surveyed area increases the vehicle's stability at the cost of less survey area covered per survey. The practically used payload weight of about 15 kg amounts to roughly 12-15 minutes of flying time for each set of batteries, which took upwards of 40 minutes to charge once used. Additionally, since a corrective model relies on yaw, pitch, and roll measurements to correct for the vehicle's orientation, this information loss may limit the ability to precisely describe the vehicle's position at every timestep, thereby directly impacting the efficacy of the B^{exp} calculation.

Even though the demonstrated embodiments of the magnetic self-noise reduction (correction) model outperform the presently-available compensation techniques that do not explicitly include information on current draws and motor speeds and enables the rigid mounting of sensitive triaxial magnetometers to the drone body, the improvement to these embodiments would be produced by the use of a higher sampling magnetometer array. For example, if the used magnetometer system could operate (sample data) at the same frequency as the vehicle sensor system (in our example—at about 25 Hz), the movement of the vehicle could be sped up by about six times for the same survey data density. This would obviate the need for down-sampling, thereby allowing for all yaw, pitch, and roll measurements to be included directly, thus improving the accuracy of the self-noise model even further and increasing the overall data fidelity. (The person of skill in the art would appreciate that the determination of the ideal sampling rate is a tradeoff between maximizing the amount of data collected and being slow enough to avoid interference with signal produced by the high-frequency anthropogenic noise sources.)

Overall, in accordance with the demonstrated non-limiting embodiments of the invention, it was demonstrated how data logged by UAV sensors may be leveraged to model and reduce vehicle magnetic self-noise. While specific operational parameters were chosen for the discussed embodiments of the model, it is to be understood that, within the scope of the invention, operational parameters of the vehicle considered for demonstration of yet another embodiment and logged in with the vehicle sensor system may vary suit specific applications. The proposed methodology is useful for any vehicle-mounted magnetometer system with an accessible vehicle sensor log. For example, the proposed methodology is not restricted to UAV-based magnetometry but may be applied to any vehicle that utilizes DC motors. Ground robotics systems such as the AeroVironment tEOD or EVO, for example, which disarms and disposes of explosive ordnance, could be fitted with TetraMag or a different magnetometer system and use the proposed approach to model and subtract out the vehicle's self-noise for UXO detection before removal.

Very few specific dedicated vehicle sensors are required for this purpose and—since it is common for at least commercial drones to log yaw, pitch, roll, Ω, and status of the electrical battery, no additional sensors may be required at least in the case of the drones to utilize the developed technique. However, this does not preclude using alternative sensors, such as higher-resolution accelerometers and/or current sensors to measure these variables, if desired. (In particular, the discussed methodology is compatible and can be used together with or in addition to that disclosed in, for example, US patent publication US 2024/0134085, the disclosure of which is incorporated herein by reference.) To measure \vec{I} in a non-invasive way, for example, a split-core current sensor can be connected to each motor wire connection for logging the data using either the flight (or, generally, vehicle movement or repositioning controller) or an external microcontroller fitted with a real-time clock.

It was demonstrated that data fidelity and spatial coherence improve dramatically when the vehicle magnetic self-noise reduction is implemented (regardless according to which of the considered embodiments—model A, or B, or C) for as compared to the results produced when only the orientation of the vehicle is taken into account by considering the geometrically corrected ambient magnetic field (B^{exp}) only. Model C, which included currents, motor speed, and the derivatives of these operational parameters of the vehicle, ultimately outperformed the other models. This aligns with the significance of the power balance equation and the motor voltage balance equation that governs the operation of the DC motors, as it is the only model that incorporates all the terms from the equations. It was additionally demonstrated that magnetic noise produced by vibration of the vehicle and/or the magnetometer platform may be suppressed with a low-pass filter, thereby further increasing data fidelity (though limiting the maximum speed of vehicle movement across and/or above the scene when mapping small-scale anomalies). The proposed methodology could be optionally improved even further by using higher sampling frequency magnetometers, enabling faster surveying velocity and wider coverage per set of batteries.

For the considered specific case of using the Freefly Alta X vehicle sensor system, a higher sampling frequency for the magnetometer system TetraMag would allow for more of the vehicle data to be used (which was discarded by downsampling in the above-discussed experiments).

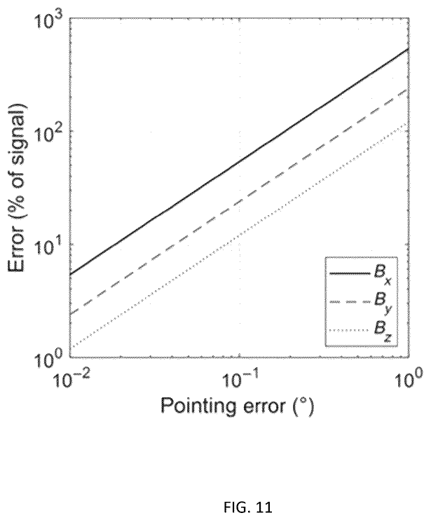

Further, the discussed approach demonstrated the increase of spatial/angular sensitivity of the measurement of the magnetic field as a result of rigid affixation of the magnetometers to the vehicle. Indeed, any error in pointing/orientation that can result from a magnetometer that is swinging around (moveably suspended with respect to the vehicle as is common in related art) can quickly result in massive spurious magnetic field signals because orientation changes how the Earth's magnetic field (which is quite strong relative to the magnetic fields produced by the sought-after small-scale anomalies) projects onto the vector components of the magnetometer. To this end, FIG. 11 (borrowed from the publication of H. Myers, et al., Geophysics, v. 90, No. 4, pp. G93-G108, 2025 the disclosure of which is incorporated by reference herein) highlights why pointing error is important when studying magnetic fields. (For the sake of reference, in FIG. 11, the tick 10² on the ordinate axis corresponds to spurious signals that are equal in magnitude to the expected signal produced by a large anti-tank mine.)

Notably, the proposed methodology is not restricted to UAV-based magnetometry but may be applied to any vehicle that utilizes DC motors. Ground robotics systems such as the AeroVironment tEOD or EVO, for example, which disarms and disposes of explosive ordnance, could be fitted with TetraMag or a different magnetometer system and use the proposed approach to model and subtract out the vehicle's self-noise for UXO detection before removal.

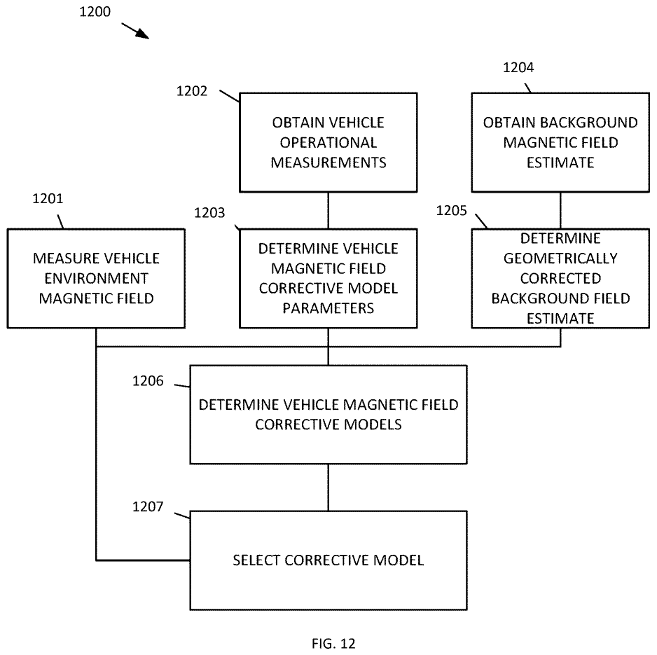

Based on the discussion presented above, the skilled person will readily appreciate that implementations of the idea of the invention allow for at least a selection of a model for reduction of the magnetic self-noise generated by the operating (moving) vehicle equipped with a set of magnetometers and for the use of the selected model to improve and increase accuracy and precision of measurements of the small-scale magnetic anomalies with such vehicle. To this end:
(A) A process of selection of the corrective model. In further reference to FIG. 2, FIG. 12 illustrates schematically an embodiment of a method 1200 for determining a vehicle magnetic field corrective model (“corrective model”), which can be carried out in one specific case by a vehicle equipped with a plurality of magnetic sensors (magnetometers) such as a four-rotor drone as discussed above (FIG. 1), for example with the use of a software program, such as a program executed by a computer/programmable processor coupled to the vehicle, integrated circuitry, such as application-specific integrated circuits (ASICs), or combinations thereof. It is to be understood that a given implementation of such method need not contain all steps or blocks depicted in FIG. 12 (whether or not specifically identified as optional) and need not be implemented with steps or blocks in the same order as depicted.

At step 1201, the vehicle environment magnetic field is being measured via a scalar magnetometer such as a total field magnetometer, a vector magnetometer, or a gradient magnetometer (gradiometer), such as a triaxial sensor, or a corresponding set of magnetometers coupled to the vehicle, to name just a few. The set of magnetometers in question measure a set of respectively corresponding magnetic field vectors ({B1, B2, B3, B4} in the example of a tetrahedral vector magnetometer assembly). At step 1202, vehicle operational measurements (parameters) are obtained via measurements of values that affect a magnetic field generated by the vehicle itself—such as electric motor operational values to estimate magnetic noise introduced by the electric motors (including motor current draw, motor angular speed, motor inductances, armature resistance, torque, or back electromotive force (EMF), to name just a few).

In one specific example (corresponding to Model A discussed above), step 1202 may include determining motor current draw and angular speed. Motor current draw may be determined in various manners, such as via measurement by built-in vehicle sensor system or as a reported value received from a vehicle control or power system. Motor angular speed may be measured in various manners, such as by local sources of vehicle sensor data, such as rotation sensors (e.g., infrared or optical RPM sensors) coupled to the vehicle motors, or remote sources of telemetry, such as radar doppler measurements, which may be transmitted to the vehicle. For instance, in an implementation performed with respect to a quadcopter drone, step 1202 may include measuring current draw values and rotational speeds of the four electric motors driving the drone rotors.

At step 1203, a plurality of vehicle magnetic field corrective model parameters is being determined based on the results of the measurements of the plurality of vehicle operational parameters performed at step 1202. Here, the parameters that depend on the vehicle operational measurements and that may affect the magnetic noise generated by the vehicle are being determined. For instance, step 1203 may include determining time derivatives of the current draw values, which may relate to voltage balances of the motors, and/or determining time derivatives of the angular speed values, which may relate to Eddy currents in the motors arising from Faraday induction. In some examples, phase delay indicators for the electric motor operational values may be determined at this step. For example, step 1203 may include performing a phase-space transform to the current draws or angular speeds. For example, Hilbert transforms may be applied to the current draw or angular speeds. A Hilbert transform of a current draw may measure the imaginary part of the analytical signal of the current draw. Other examples may include performing other transforms that provide phase delay information (e.g., via Laplace transform operations).

At block 1204, the embodiment of the method 1200 may include obtaining an estimate of the background (ambient) magnetic field for the vehicle. The background magnetic field value at least in one case corresponds to a magnetic field produced by a planet or known environmental field sources. For example, in a terrestrial implementation, the estimated background (ambient) magnetic field value is obtained based on the World Magnetic Model or Enhanced Magnetic Model evaluated at the vehicle's position. In some cases, the vehicle's position may be determined via global navigation satellite system (GNSS) signals, such as the Global Positioning System (GPS). In an aerial implementation, the vehicle position may include altitude. For example, step 1204 may include obtaining a vehicle altitude using an altimeter, such as a laser range finder, thereby resulting in obtaining the estimated background magnetic field value based on the World Magnetic Model or Enhanced Magnetic Model evaluated at the vehicle's position and altitude. Understandably, in a related embodiment separate background magnetic field estimates may be obtained for separate magnetometers of the vehicle. For example, sensor positions may be determined based on a separation distance between an attitude sensor and magnetometers before querying the WMM for that particular magnetometer.

At step 1205, an estimate of a geometrically corrected background (ambient) field is produced, which accounts for an orientation of the vehicle at a given vehicle's location and a reference orientation associated with a magnetic model. In some examples, step 1205 may include obtaining vehicle orientation data, such as yaw, pitch, and roll of the vehicle, to project the background (ambient) field values available from step 1204 onto the plane of the vehicle. For example, yaw, pitch, and roll may be used to construct a rotation matrix that may be applied to the background magnetic field.

In some specific implementations, steps 1201-1205 may include additional data signal processing operations. For example, a low-pass filter may be applied to data obtained at these steps to compensate for small or rapid vehicle movements (such as those caused by vehicle vibrations) that may also introduce magnetic noise. For example, a low-pass filtering with a predetermined cutoff frequency may be defined based on typical magnetic field variations being measured. In a specific example discussed above (where a drone was used to identify buried objects (e.g., landmines, unexploded ordinance, or other targets), a 0.1 Hz-1 Hz low-pass filter (e.g., a 0.25 Hz) filter was applied to the vehicle sensor data and the magnetometer data. As another example of additional data processing operations, steps 1201-1205 may include a resampling of data to ensure that the magnetic field data and the vehicle sensor data are at a common frequency. For example, data received from an inertial measurement unit or other vehicle sensor may be down-sampled to match the sampling rate of a particular magnetometer.

At step 1206, at least one embodiment of the vehicle magnetic field corrective model is formed or determined (in the examples discussed above—Model A, Model B, Model C). Different embodiments are determined based on different sets of the vehicle magnetic field corrective model parameters. For example, parameters for a first model might include a geometrically corrected background magnetic field (step 1205), motor current draws, motor angular rotations, motor current phase, and motor angular rotation phase. Another (second) model may be based on consideration of a geometrically corrected background magnetic field, motor current draw time derivatives, motor angular rotation time derivatives, motor current phases, and motor angular rotation phases, while yet another (third) model might include the use of a geometrically corrected background magnetic field, motor current draws, motor current draw time derivatives, motor angular rotations, motor angular rotation time derivatives, motor current phases, and motor angular rotation phases. Yet another embodiment of the (fourth) model may be based on the use of a geometrically corrected background magnetic field, motor current draws, motor current draw time derivatives, motor angular rotations, motor current phases, and motor angular rotation phases. Understandably, the formation or determination of the embodiment of the vehicle magnetic self-noise corrective model at step 1206 may involve determination of a plurality of linear regression models based on corresponding sets of parameters—such as, e.g., a step of calculating linear regression coefficients that fit a linear regression model to magnetic data recorded over an area (e.g., a calibration flight over a predetermined calibration or training area or scene). The linear regression coefficients (weight coefficients) may be vector valued when the corresponding operational parameters of the vehicle are vector valued and/or be determined according to a least-squares or other fitting approach. For example, step 1206 may include a process of applying a least-squares ellipsoid fit based on the measured magnetic field (see step 1201) or, alternatively, other best fit approaches or support vector regression models.

Step 1207 may include a process of selection of a corrective model for vehicle magnetic self-noise correction and use of the selected model to determine error values associated with measured magnetic field components. For instance, step 1207 may include determining error values for each component for each magnetic sensor of the vehicle, such as root mean squared error (RMSE) values. As another example, at step 1207 the determination of a magnetic gradient tensor based on the measured magnetic field (such as a finite-difference magnetic gradient tensor) may be performed. In this example, step 1207 may include determining error values for tensor components associated with the chosen model. Overall, a particular corrective model may be selected according to specific criteria such as, for example, based on the smallest mean error value (e.g., mean RMSE), or the smallest total error (e.g., total RMSE summed over all field components), or based on based on comparisons of errors associated with field components among different embodiments of the models determined at step 1206. For instance, a model may be selected based on a lowest z-field component error, a sum or average over a selected subset of tensor components, or other implementation-specific considerations (here, for example, an implementation performed by a landmine-detecting drone copter might have different selection criteria than an implementation performed by a metal-seeking submarine).

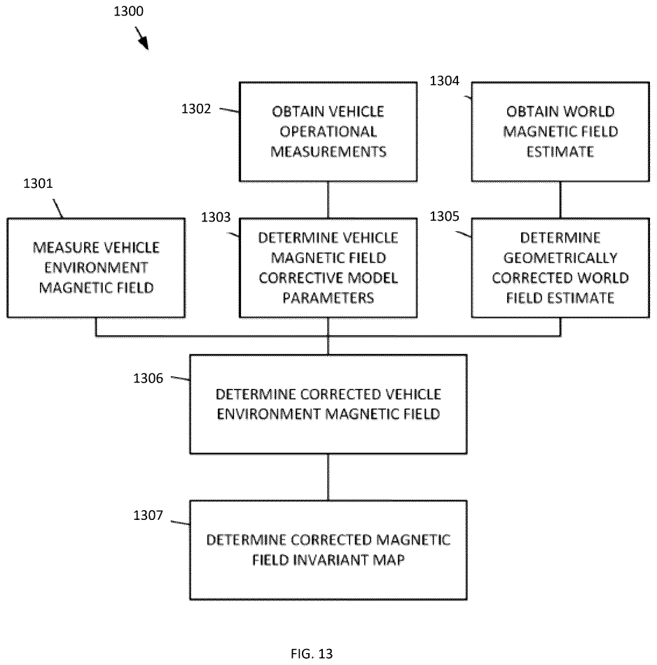

(B) Example of the Use of the Selected Model. FIG. 13 illustrates schematically an embodiment 1300 of implementation of the vehicle magnetic self-noise reduction methodology to create a magnetic field invariant map which map may be used to detect target objects, such as objects buried underground or under water). In a specific case, the embodiment 1300 may be performed as an implementation of embodiment 1200 of FIG. 12. For instance, steps 1301-1305 of embodiment 1300 may be carried out as steps 1201-1205 of FIG. 12, respectively. In such specific case, steps 1306 and 1307 may be performed after step 1207 of FIG. 12. Alternatively, the method 1300 may be carried out apart from the method 1200: for example, the method 1200 can be carried out as part of a calibration procedure and method 1300 might be performed as an aspect of a normal operation of the same vehicle.

Steps 1301-13-05 may be generally performed in a manner described with respect to steps 1201-1205 of FIG. 12. In some examples, steps 12-01-12-05 may be performed with respect to a particular magnetic self-noise corrective model—for example, to obtain and determine data according to the parameters included in the selected magnetic self-noise corrective model. For instance, if the first model of the four-model example alluded to above was selected, then steps 1302 and 1303 may include obtaining motor current draws and motor angular rotations (at step 1302) and determining motor current phase and motor angular rotation phase (at step 1303). As another example, if the third model discussed above was selected, then step 1303 may include determining motor current draw time derivatives, motor angular rotations, motor angular rotation time derivatives, motor current phases, and motor angular rotation phases.

At step 1306, determination of a corrected vehicle environment magnetic field is performed by applying the selected vehicle magnetic self-noise corrective model (for example, that selected at step 1207 of the process 1200) to magnetic field data measured at step 1301. In one instance, step 1306 may include determining an estimated environmental magnetic field tensor by correcting a measured magnetic field tensor. At step 1307, calculation of the magnetic field invariant map is carried out. A magnetic field invariant map may include a process of establishing one-to-one correspondence (mapping) between an invariant of the corrected magnetic field data and locations at the scene to be mapped/area where the magnetic field was measured by the vehicle's magnetometers. For instance, step 1307 may include calculating invariants of the magnetic gradient tensor determined at step 1306 at locations where the gradient tensor was measured. For example, FIG. 10 illustrates an example of a particular image (in this case—a visual display) of a map representing a determinant of a symmetric part of a magnetic field gradient tensor at various locations in a target search field.

In some examples, invariant maps may be used to detect magnetic targets (e.g., landmines or other buried objects) via visual inspection of a system operators or by being analyzed with the use of chosen image/data processing techniques (such as edge detection techniques, pattern recognition, template matching, neural networks, deep learning/machine learning processing models, filtering operations, thresholding operations, or other processing operations). In one non-limiting example, an invariant map such as that of FIG. 10 may be analyzed via a convolutional neural network trained to detect potential ferrous objects.

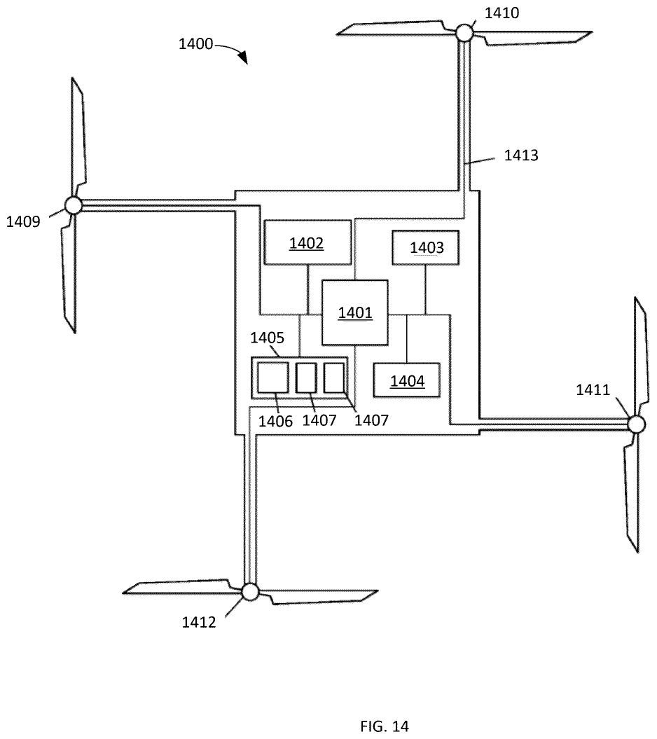

The discussion would not be complete without referring to FIG. 14, which presents a block diagram illustrating a typical vehicle 1400 that is equipped with the set of magnetic sensors 1402 and is configured to carry out at least a part of a particular implementation of the methodology of the invention. (For example, vehicle 1400 may be configured as a quadcopter drone, illustrated in FIG. 1. Alternatively, the vehicle 1400 may include a submarine, a winged drone, a ground vehicle, a floating vehicle, an aerial vehicle, a spacecraft, a subterranean manned or unmanned vehicle (such as a boring system of a down-well system), an unmanned aerial vehicle (UAV), an autonomously controlled UAV, a ground-based vehicle, an unmanned ground vehicle (UGV), an autonomously controlled UGV, or other vehicle carrying the vehicle sensor system (such as a telemetry system in one example) and the set of magnetic sensors. Depending on the specifics of a particular implementation, the vehicle 1400 may contain an electric power source 1401 (i.e., a battery, a photovoltaic power source such as a solar panel, a nuclear battery such as a radioisotope generator, a hydrogen fuel cell, an internal-combustion generator, or other suitable power source). In at least one case, the power source 1401 may include or be operably coupled—for example, at least electrically—with a sensor or other telemetry device or system to collect/record the operational parameters. For example, power source 1401 may include a current sensor, a voltage sensor, or other power sensor.

The vehicle 1400 may additionally include a vehicle control unit (VCU) 1405, appropriately structured to govern the operation of the vehicle 1400. For example, the VCU 1405 may incorporate a programmable processor or electronic circuitry 1406 (such as a suitable hardware processor or combination of processors—a central processing unit (CPU), a graphics processing unit (GPU), an application specific integrated circuit (ASIC), a field-programmable gate array (FPGA), a digital signal processor (DSP), or a microcontroller (MCU), to name just a few). Additionally, the VCU 1405 may include tangible non-transitory storage memory 1407, optionally including any suitable storage device or devices that can be used to store suitable data and instructions that can be used by the processor 1406 to perform any of the following activities or a combination of such activities: to control the operation of the vehicle 1400, to receive data from an operator/user, to receive vehicle operational data from the vehicle sensor system, to retrieve magnetic data from the magnetometers, to generate magnetic self-noise corrective models, apply magnetic self-noise corrective models, or perform other operations as described herein. The memory 1407 can generally be configured as any suitable volatile memory, non-volatile memory, storage, or any suitable combination thereof. For example, the storage memory 1407 can include random access memory (RAM), read-only memory (ROM), flash memory, field programmable unit (FPU), electronically erasable programmable read-only memory (EEPROM), storage such as solid state or hard disk drives, etc.

In further examples, the VCU 1405 may include a communications system 1408 such as any suitable hardware, firmware, or software for communicating information over a communication network. For example, communications system 1408 can include one or more transceivers, one or more communication chips and/or chip sets, etc. In a more specific example, the communications system 1408 may include hardware, firmware or software structured to be used to establish a Wi-Fi connection, a Bluetooth connection, a cellular connection, etc. In further examples, communications system 148 may include hardware, firmware, or software to communicate with other components of the vehicle 1400. (For example, communications system 1408 may contain an I2C, I3C, or JTAG interface, or vehicle-internal communication interface.) For instance, communications system 1408 may be configured to receive vehicle operational data, magnetic data, or vehicle location data, to name just a few.

In yest another example, the VCU 1405 may include a user interface such as a port for a wired connection to a user device (e.g., a USB port for a laptop or mobile device connection) and/or a graphical display screen, a key input interface, indicator lights, or other user interface components.

As is already appreciated, the vehicle 1400 carries a magnetic sensor system 1402 (such as the discussed above rigidly affixed to the vehicle magnetometer assembly, or a slung magnetometer assembly, or an internal magnetometer assembly) that contains various magnetometers (such as a scalar magnetometer, a vector magnetometers, a gradient vector magnetometers, to name just a few). Alternatively or in addition, the vehicle 1400 is preferably equipped with a positioning system 1403 such as a GNSS receiver system, a beacon or beacon receiver, a radar system, etc), which positioning system may be structured to identify a three-dimensional position of the vehicle 1400 in the chosen system of coordinate. The positioning system 1403 may contain an altimeter, such as a barometer or laser rangefinder, and/or an underwater depth sensor, for example. The vehicle 1400 includes a vehicle sensor system 1404, which contains a sensor system configured to determine the orientation of the vehicle with respect to a reference orientation. (here, in one non-limiting example, the vehicle sensor system 1404 includes an accelerometer, a gyroscope, an inertial measurement unit) and/or sensors to measure the status of various vehicle 1400 components or operations. Preferably, the vehicle sensor system 1404 is connected to the vehicle electric motors 1409, 1410, 1411, 1412 to measure motor operational data, such as motor angular speeds, and/or includes power measuring devices connected to power lines 1412 that transmit power to the vehicle motors 1409, 1410, 1411, 1412.

Processor 1406 is preferably configured to execute at least a portion of either of the methods 1200, 1300 described above in connection with FIGS. 12 and 13. For example, the processor 1406 may be configured to execute the entire embodiment of a method, including retrieval of data from systems 1402, 1403, 1404, processing of the data, development of magnetic self-noise correction models, application of the chosen of the models, and/or generation of an image of the spatial distribution of the magnetic anomalies across the area of the scene to be mapped and/or determination of invariant maps. Alternatively or in addition, the processor 1406 may be configured to execute at least a portion of either method 1200, 1300 in conjunction with other connected systems. (For example, the processor 1406 may govern the communication system 1408 to transmit data to a remote location—e.g., a remote server or operator's laptop—for operations to be performed remotely; to transmit data to a remote computer that creates and selects a magnetic model (e.g., performs steps 1206, 1207) remotely with respect to the vehicle 1400. In this latter example, processor 1406 may receive corrective model determined and selected remotely via communication system 308 and apply such corrective model at the vehicle to magnetic field readings (e.g., perform the step 1306 at the vehicle). The processor 1407 may further generate an image of the spatial distribution of the magnetic anomalies across the area of the chosen scene and/or a corrected magnetic field invariant map as described with respect to the step 1307, or, alternatively, have the data for determination of such image/invariant map transmitted to a remote location, where such image/map are generated.

For the purposes of this disclosure and accompanying claims, the term “image” as used herein refers to an ordered representation of detector signals corresponding to spatial positions. For example, an image may be an array of values within an electronic memory, or, alternatively, a visual or visually-perceivable image (such as a map or a multi-layer map, in one example) may be formed on a display device X such as a video screen or printer. A “real-time” performance of a system is understood as performance that is subject to operational deadlines from a given event to a system's response to that event. For example, a real-time determination of the vehicle's own magnetic field parameters may be one triggered by the user or computer processor and executed substantially simultaneously with and without interruption of the measurement of parameters of operation of the vehicle responsible for formation of such vehicle's own magnetic field and/or of the recordation of such parameters. The expression “A and/or B” is equivalent to “A, or B, or combination of A and B.”

Embodiments of the invention have been described as including a processor or programmable electronic circuitry controlled by instructions stored in a memory. The computer program product, including the tangent non-transitory storage memory containing code and/or instructions, which, when loaded onto such processor, enable the processor to effectuate the steps of at least the embodiments of the methods discussed above, remain within the scope of the invention. Such storage memory may be random access memory (RAM), read-only memory (ROM), flash memory or any other memory, or combination thereof, suitable for storing control software or other instructions and data. Instructions or programs defining the functions of the present invention may be delivered to the processor/electronic circuitry in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. Indeed, as understood by a skilled artisan, the practical deviation of the exact value or characteristic of such value, element, or property from that stated falls and may vary within a numerical range defined by an experimental measurement error that is typical when using a measurement method accepted in the art for such purposes.

For example, a reference to an identified vector or line or plane being substantially parallel to a referenced line or plane is to be construed as such a vector or line or plane that is the same as or very close to that of the referenced line or plane (with angular deviations from the referenced line or plane that are considered to be practically typical in related art, for example between zero and fifteen degrees, preferably between zero and ten degrees, more preferably between zero and 5 degrees, even more preferably between zero and 2 degrees, and most preferably between zero and 1 degree). The use of the term “substantially flat” or “substantially planar” in reference to the specified surface implies that such surface may possess a degree of non-flatness and/or roughness that is sized and expressed as commonly understood by a skilled artisan in the specific situation at hand. Other specific examples of the meaning of the terms “substantially”, “about”, and/or “approximately” as applied to different practical situations may have been provided elsewhere in this disclosure.

While the invention is described through the above-described examples of the embodiments, it will be understood by those of ordinary skill in the art that modifications to, and variations of, the illustrated embodiments may be made without departing from the inventive concepts disclosed herein. Disclosed aspects of the implementations of the idea of the invention, or portions of these aspects, may be combined in ways not listed above. Accordingly, the invention should not be viewed as being limited to the disclosed embodiment(s).

What is claimed is:

1. A vehicle-based apparatus configured to reduce errors of detecting magnetic anomalies at a scene to be mapped with the use of a vehicle, the apparatus comprising:
the vehicle;
a magnetometer system including a set of magnetic sensors attached to the vehicle;
a vehicle sensor system at least electrically coupled with an operational component of the vehicle;
and
a programmable electronic circuitry in operable communication with the set of magnetic sensors and the vehicle sensor system, the electronic circuitry being configured:
to receive ambient magnetic data characterizing an ambient magnetic field at a location and altitude of the vehicle;
to transform the ambient magnetic data to geometrically corrected ambient magnetic data representing a geometrically corrected ambient magnetic field dependent on an orientation of the vehicle at the location and altitude;
to determine characteristics of a local magnetic field produced by the vehicle, operating to detect the magnetic anomalies at the location of the scene, based at least on vehicle operational parameters measured with the vehicle sensor system while said operating; and
to generate an image of a spatial distribution of the magnetic anomalies across an area of the scene to be mapped by at least compensating the geometrically corrected ambient magnetic field with a corrective magnetic field determined with the use of the characteristics of the local magnetic field.

2. A vehicle-based apparatus according to claim 1, wherein the vehicle includes an aerial vehicle, an unmanned aerial vehicle (UAV), an autonomously controlled UAV, a ground-based vehicle, an unmanned ground vehicle (UGV), an autonomously controlled UGV, a subterranean manned or unmanned vehicle, a manned or unmanned spacecraft, a manned or unmanned surface ship, or manned or unmanned submarine.

3. A vehicle-based apparatus according to claim 1, wherein the magnetometer system comprises a triaxial magnetometer, a magnetometer array, a scalar magnetic sensor, a vector magnetic sensor, a quantum magnetic field sensor, or a combination thereof.

4. A vehicle-based apparatus according to claim 1, wherein the vehicle sensor system includes a first vehicle sensor configured to measure said vehicle operational parameters that include a time-dependent power bus current of the vehicle, a second vehicle sensor configured to measure a rotational speed of the motor during said operating, or a combination thereof.

5. A vehicle-based apparatus according to claim 1, wherein the vehicle sensor system is configured to measure at least yaw, pitch, and roll of the vehicle at the location during said operation.

6. A vehicle-based apparatus according to claim 1, wherein the programmable electronic circuitry is further configured to determine the location, altitude, and/or orientation of the vehicle based on data provided by a vehicle-locating system.

7. A vehicle-based apparatus according to claim 1, wherein said programmable electronic circuitry is configured to carry out any of (i) transforming the ambient magnetic data to geometrically corrected ambient magnetic data, (ii) determining the characteristics of the local magnetic field produced by the vehicle while operating, (iii) generating the image of the spatial distribution of the magnetic anomalies across the area of the scene to be mapped, or (iv) combination thereof, either in real time with said operating or in post-processing.

8. A vehicle-based apparatus according to claim 1, wherein said image is a visually-perceivable image.

9. A vehicle-based apparatus according to claim 1, wherein the programmable electronic circuitry is configured to carry out said compensating based on data representing weights corresponding to the vehicle operational parameters, wherein the weights have been determined with a model trained on first training data acquired during operation of the vehicle under conditions that substantially exclude or avoid or prevent sensing of the magnetic anomalies by the set of the magnetic sensors.

10. A vehicle-based apparatus according to claim 9, wherein said conditions include operating the vehicle at an auxiliary scene that is substantially devoid of the magnetic anomalies or operating the vehicle above the scene to be mapped at a separation from the scene to be mapped that causes a signal, generated by the magnetic anomalies of the scene to be mapped at the magnetic sensors, to be substantially reduced in magnitude.

11. A method, comprising:
with the use of the apparatus of claim 1:
measuring a plurality of vehicle operational parameters;
determining a plurality of parameters of a vehicle magnetic field corrective model based on said plurality of vehicle operational parameters;
measuring a vehicle environment magnetic field;
identifying a plurality of vehicle magnetic fields corrective models based on the plurality of parameters of the vehicle magnetic field corrective model;
selecting a vehicle magnetic field corrective model based on the vehicle environment magnetic field.

12. A method according to claim 11, further comprising determining a corrected vehicle magnetic field by applying the vehicle magnetic field corrective model to the vehicle environment magnetic field.

13. A method according to claim 12, further comprising calculating a magnetic field invariant map of a target area based on the corrected vehicle magnetic field.

14. A method according to claim 13, further comprising detecting an object buried at the target areas based on the magnetic field invariant map.

15. A method according to claim 11, wherein the plurality of vehicle operational parameters comprises a rotational speed of an electric motor of the vehicle and a power bus current of the vehicle.

16. The method according to claim 11, wherein the plurality of the parameters of the vehicle magnetic field corrective model comprises the plurality of the vehicle operational parameters, a plurality of time derivatives of said vehicle operational measurements, and phase characteristic associated with the vehicle operational parameters.

17. A method according to claim 16, further comprising selecting a subset of the plurality of the parameters of the vehicle magnetic field corrective model based on a vehicle magnetic field corrective model identified with said selecting.

18. A method for identifying magnetic anomalies at a scene to be mapped, the method comprising:
for each location of a vehicle moving above the scene to be mapped, wherein the vehicle carries a magnetometer system that contains a set of magnetic sensors attached to the vehicle and a vehicle sensor system at least electrically coupled with an operational component of the vehicle:
determining a local magnetic field produced by the moving vehicle at a location, an altitude, and an orientation of the vehicle based at least one a plurality of operational parameters of the vehicle measured with the vehicle sensor system during said moving above the scene to be mapped and corresponding weight values generated with a model trained on training magnetic field data acquired from the set of magnetic sensors; and
forming an image, of a spatial distribution of said magnetic anomalies across the scene to be mapped, in which an image noise is reduced by an amount corresponding to said local magnetic field.

19. A method according to claim 18, further comprising:
transforming first parameters representing an ambient magnetic field at the location and the altitude of the vehicle to second parameters of a geometrically corrected ambient magnetic field that is dependent on the orientation of the moving vehicle at the location and the altitude.

20. A method according to claim 18, further comprising:
generating the weight values includes minimizing a difference between
(i) a first magnetic field predicted by the model with the use of telemetry system data and data representing a geometrically corrected ambient magnetic field that is dependent on the orientation of the moving vehicle at the location and the altitude; and
(ii) the training magnetic field data.
